(19) United States
(12) Patent Application Publication
(10) Pub. No.: US 2017/0171169 A1
(43) Pub. Date: Jun. 15, 2017

(54) PACKET NUMBER DETERMINATION IN A NEIGHBOR AWARE NETWORK

(71) Applicant: QUALCOMM Incorporated, San Diego, CA (US)

(72) Inventors: Soo Bum Lee, San Diego, CA (US); Santosh Abraham, San Diego, CA (US); Abhishek Pramod Patil, San Diego, CA (US); Jouni Malinen, Tuusula (FI); George Cherian, San Diego, CA (US)

(21) Appl. No.: 15/377,819

(22) Filed: Dec. 13, 2016

Related U.S. Application Data
(60) Provisional application No. 62/267,250, filed on Dec. 14, 2015.
(60) Provisional application No. 62/306,484, filed on Mar. 10, 2016.

(51) Int. Cl. H04L 29/06; H04W 56/00; H04L 9/08; H04L 12/26; H04W 76/06; H04W 12/04; H04L 29/12; H04W 4/06

(52) U.S. Cl. CPC H04L 63/0428; H04L 61/6022; H04W 56/0015; H04W 4/06; H04L 43/16; H04W 76/06; H04L 63/065; H04W 12/04; H04L 63/068; H04L 9/0861

(57) ABSTRACT

A wireless communication device includes a memory and a processor coupled to the memory. The processor is configured to set a packet number to a particular value in accordance with a packet number initialization scheme associated with a data link group of a neighbor aware network (NAN). The processor is further configured to generate a packet based on the packet number.

### I. CROSS-REFERENCE TO RELATED APPLICATIONS

The present application claims priority from U.S. Provisional Patent Application No. 62/267,250, filed Dec. 14, 2015, and entitled “PACKET NUMBER DETERMINATION IN A NEIGHBOR AWARE NETWORK”, and U.S. Provisional Patent Application No. 62/306,484, filed Mar. 10, 2016, and entitled “PACKET NUMBER DETERMINATION IN A NEIGHBOR AWARE NETWORK”; the contents of each of the aforementioned applications are expressly incorporated herein by reference in their entirety.

### II. FIELD

The present disclosure is generally related to packet number determination in a neighbor aware network (NAN).

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Wireless devices, such as wireless telephones, may use wirelessly transmit and receive data from other wireless devices. To increase security of data transmissions between wireless devices, data may be encrypted prior to being transmitted. Particular types of encryption may be specified in various wireless standards. For example, the Institute of Electrical and Electronics Engineers (IEEE) 802.11s standard specifies that data is to be encrypted using Counter mode with Cipher-block chaining Message authentication code protocol (CCMP) encryption.

To perform CCMP encryption, a device generates a nonce and encrypts data based on the nonce and a temporal key (e.g., a pairwise transient key or a group temporal key). The device generates the nonce based on a media access control (MAC) address of the device and based on a packet number associated with the packet (e.g., the data) to be transmitted by the device. To enable a receiver to decrypt and verify the packet, the device may include a packet number (e.g., in the CCMP header, such as in the case of an IEEE 802.11 frame). The device may be configured to maintain a packet number counter associated with a data link group (e.g., a NAN data link (NDL)), and the packet number counter may be used to set a value of the packet number in the CCMP header. The packet number counter is incremented after each packet is generated. Accordingly, when the device initiates generation of a new packet, the device generates a nonce corresponding to the new packet based on an incremented packet number.

If the device is powered down, experiences a system failure, or is disassociated, a value stored by the packet number counter may be lost. After power-up (or system recovery), the device may reset the packet number counter to a particular (e.g., pre-programmed) initial value (e.g., zero). The initial value, or a value subsequent to the initial value, may have already been used to generate a nonce for a particular temporal key (e.g., when a single group key is used and has not been changed since the device was disassociated from the group). If the particular temporal key has not expired, the device may generate a nonce (e.g., based on the particular temporal key and the initial value) that has already been used to encrypt data. Re-using nonces (e.g., using nonces based on the same temporal key and the same packet number) violates a security criterion of CCMP encryption.

### IV. SUMMARY

In a particular aspect, a method of wireless communication includes, at a first device, performing one or more operations to join a data link group of a neighbor aware network (NAN). The method includes setting a packet number to a particular value in accordance with a packet number initialization scheme of the data link group. The method further includes generating a packet based on the packet number. For example, the packet may include data that is encrypted based on a nonce, and the nonce may be generated based on the packet number.

In another particular aspect, a device includes a packet number generator configured to set a packet number to a particular value in accordance with a packet number initialization scheme associated with a data link group of a neighbor aware network (NAN). In a particular implementation, the packet number may be set to a particular value based on a timing synchronization function (TSF), in accordance with a first packet number initialization scheme. In another particular implementation, the packet number may be set to a particular value based on a packet number initialization value stored at a non-volatile memory of the device, in accordance with a second packet number initialization scheme. The device further includes a packet generator configured to generate a packet based on the packet number.

In another particular aspect, a method of wireless communication includes determining, at a first device of a data link group of a neighbor aware network (NAN), whether an expiration condition associated with a first group key of the data link group is satisfied based on a subset of bits of a timing synchronization function (TSF) value of the data link group or based on a packet number initialization value stored at a non-volatile memory of the device. The method further includes initiating a group key expiration action in response to the expiration condition being satisfied.

In another particular aspect, a device includes a key expiration monitor configured to determine whether an expiration condition associated with a first group key of a data link group of a neighbor aware network (NAN) is satisfied based on a subset of bits of a timing synchronization function (TSF) value of the data link group or based on a packet number initialization value stored at a non-volatile memory. The device further includes a data link group manager configured to initiate a group key expiration action in response to the expiration condition being satisfied.

In another particular aspect, a method of wireless communication includes determining, at a first device of a data link group of a neighbor aware network (NAN), whether an expiration condition associated with a first group key of the data link group is satisfied based on a subset of bits of a timing synchronization function (TSF) value of the data link group or based on a packet number initialization value stored at a non-volatile memory of the first device. The method further includes initiating generation of a second group key of the data link group at the first device in response to the expiration condition being satisfied.

In another particular aspect, a device includes a key expiration monitor configured to determine whether an expiration condition associated with a first group key of a data link group of a neighbor aware network (NAN) is satisfied based on a subset of bits of a timing synchronization function (TSF) value of the data link group or based on a packet number initialization value stored at a non-volatile memory. The device further includes a key generator configured to initiate generation of a second group key of the data link group in response to the expiration condition being satisfied.

In another particular aspect, a method of wireless communication includes determining, at a device of a data link group of a neighbor aware network (NAN), whether an expiration condition associated with a group key of the data link group is satisfied based on a subset of bits of a timing synchronization function (TSF) value of the data link group or based on a packet number initialization value stored at a non-volatile memory of the device. The method further includes initiating a tear down operation for the data link group in response to the expiration condition being satisfied.

In another particular aspect, a device includes a key expiration monitor configured to determine whether an expiration condition associated with a first group key of a data link group of a neighbor aware network (NAN) is satisfied based on a subset of bits of a timing synchronization function (TSF) value of the data link group or based on a packet number initialization value stored at a non-volatile memory. The device further includes a data link group manager configured to initiate a tear down operation for the data link group in response to the expiration condition being satisfied.

In another particular aspect, a method includes receiving a frame at a first device from a second device of a data link group of a neighbor aware network (NAN). The frame may indicate a timing synchronization function (TSF) value. The method includes determining a packet number based on the TSF value. The method further includes generating a packet based on the packet number.

In another particular aspect, a device includes a wireless interface configured to receive a frame from a second device of a data link group of a neighbor aware network (NAN). The frame may indicate a timing synchronization function (TSF) value. The device includes a packet number generator configured to determine or initialize a packet number based on the TSF value. The device further includes a packet generator configured to generate a packet based on the packet number.

In another particular aspect, a method includes determining, at a first device of a data link group of a neighbor aware network (NAN), a timing synchronization function (TSF) value of the data link group. The method includes determining whether an expiration condition associated with a first group key of the data link group is satisfied based on a subset of bits of the TSF value. The method further includes initiating generation of a second group key of the data link group at the first device in response to the expiration condition being satisfied.

In another particular aspect, a device includes a key expiration monitor configured to determine whether an expiration condition associated with a first group key of a data link group of a neighbor aware network (NAN) is satisfied based on a subset of bits of a timing synchronization function (TSF) value of the data link group. The device further includes a key generator configured to initiate generation of a second group key of the data link group in response to the expiration condition being satisfied.

In another particular aspect, a method includes determining, at a device of a data link group of a neighbor aware network (NAN), a timing synchronization function (TSF) value of the data link group. The method includes determining whether an expiration condition associated with a group key of the data link group is satisfied based on a subset of bits of the TSF value. The method further includes initiating a tear down operation for the data link group in response to the expiration condition being satisfied.

In another particular aspect, a device includes a key expiration monitor configured to determine whether an expiration condition associated with a first group key of a data link group of a neighbor aware network (NAN) is satisfied based on a subset of bits of a timing synchronization function (TSF) value of the data link group. The device includes a data link group manager configured to initiate a tear down operation for the data link group in response to the expiration condition being satisfied.

In another particular aspect, a device includes a memory configured to store instructions and a processor coupled to the memory. The processor and the memory are configured to join a data link group of a neighbor aware network (NAN). The processor and the memory are configured to set a packet number to a particular value in accordance with a packet number initialization scheme of the data link group. The processor and the memory are further configured to generate a packet based on the packet number.

In another particular aspect, a device includes a memory configured to store instructions and a processor coupled to the memory. The processor and the memory are configured to determine whether an expiration condition associated with a first group key of a data link group of a neighbor aware network (NAN) is satisfied based on a subset of bits of a timing synchronization function (TSF) value of the data link group or based on a packet number initialization value stored at a non-volatile memory. The processor and the memory are further configured to initiate generation of a second group key of the data link group in response to the expiration condition being satisfied.

In another particular aspect, a device includes a memory configured to store instructions and a processor coupled to the memory. The processor and the memory are configured to determine whether an expiration condition associated with a first group key of a data link group of a neighbor aware network (NAN) is satisfied based on a subset of bits of a timing synchronization function (TSF) value of the data link group or based on a packet number initialization value stored at a non-volatile memory. The processor and the memory are further configured to initiate a tear down operation for the data link group in response to the expiration condition being satisfied.

Other aspects, advantages, and features of the present disclosure will become apparent after a review of the entire application, including the following sections: Brief Description of the Drawings, Detailed Description, and the Claims.

### V. BRIEF DESCRIPTION OF THE DRAWINGS

FIG. 1 is a block diagram of a system that prevents nonce re-use with a particular group key at devices of a data link group of a neighbor aware network (NAN);

FIG. 2 is a block diagram of components of a device of a data link group that is configured to prevent nonce re-use with a particular group key;

FIG. 3 is a ladder diagram illustrating a first example of operation of devices of the system of FIG. 1;

FIG. 4 is a ladder diagram illustrating a second example of operation of devices of the system of FIG. 1;

FIG. 5 is a flow diagram of an illustrative method of setting a packet number to a particular value in accordance with a packet number initialization scheme of a data link group;

FIG. 6 is a flow diagram of an illustrative method of initiating generation of a new group key in response to an expiration condition of a group key being satisfied;

FIG. 7 is a flow diagram of an illustrative method of initiating a tear down operation for a data link group in response to an expiration condition of a group key being satisfied;

FIG. 8 is a flow diagram of an illustrative method of determining a packet number based on a time synchronization function (TSF) value;

FIG. 9 is a flow diagram of an illustrative method of initiating generation of a new group key in response to an expiration condition of a group key being satisfied;

FIG. 10 is a flow diagram of an illustrative method of initiating a tear down operation for a data link group in response to an expiration condition of a group key being satisfied;

FIG. 11 is a flow diagram of an illustrative method of initiating a group key expiration action in response to an expiration condition of a group key being satisfied; and

FIG. 12 is a diagram of a wireless device that is operable to support various aspects of one or more methods, systems, apparatuses, and/or computer-readable media disclosed herein.

### VI. DETAILED DESCRIPTION

Particular aspects of the present disclosure are described below with reference to the drawings. In the description, common features are designated by common reference numbers throughout the drawings. As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

As used herein, various terminology is for the purpose of describing particular implementations only and is not intended to be limiting of implementations. For example, the singular forms “a,” “an,” and “the” are intended to include the plural forms as well, unless the context clearly indicates otherwise. As used herein, the term “set” refers to one or more of a particular element. As used herein, the term “plurality” refers to multiple (e.g., two or more) of a particular element. It may be further understood that the terms “comprises” and “comprising” may be used interchangeably with “includes” or “including.” Additionally, it will be understood that the term “wherein” may be used interchangeably with “where.”

Systems and methods to prevent nonce re-use in a data link group of a neighbor aware network (NAN) are disclosed. Devices of the data link group may be configured to determine or set packet numbers to particular values based on a packet number initialization scheme associated with the data link group. Because a device sets a packet number to a particular value in accordance with the packet number initialization scheme, the device may be prevented from re-using packet numbers during a lifetime of a group key associated with the data link group, as further described herein. Preventing re-use of packet numbers associated with a group key at devices of the data link group meets a security requirement of at least one form of data encryption. For example, preventing re-use of packet numbers associated with a group key at devices of the data link group meets a security requirement of counter mode cipher block chaining message authentication code protocol (CCMP) encryption.

In a particular implementation, the packet number initialization scheme includes setting one or more packet numbers based on one or more timing synchronization function (TSF) values. In this implementation, a device of the data link group may be configured to set a packet number to a particular value based on a TSF value in response to the device joining the NAN (or the data link group). The TSF value may be a value that is provided to devices of the NAN for use in clock synchronization and other timing functions. For example, a device acting as an “anchor master” device of the NAN may transmit a frame that includes the TSF value to other devices of the NAN. The TSF value may be determined by the anchor master device based on an internal clock, and the TSF value may indicate a time associated with the NAN, such as an amount of time that the NAN has been in existence. The frame (including the TSF value) may be included in a NAN beacon message or a synchronization message sent by the anchor master device.

A device of the NAN may receive the frame, either from the anchor master device or via forwarding by another device of the NAN, and the device may determine the TSF value indicated by the frame. The device may set or determine a packet number based on the TSF value in response to the device joining or rejoining the NAN (or a data link group of the NAN). For example, after power-on, the device may receive the frame and set an initial value of a packet number counter to a particular value based on the TSF value. As another example, the device may set the value of the packet number counter to a particular value based on the TSF value at particular times during operation. The packet number counter may be a forty-eight-bit counter, and the device may set the value of the packet number counter based on a result of a modulo (%) operation on the TSF value by 2⁴⁸. Because the TSF value is continuously updated during a lifetime of the NAN, the TSF value may not repeat. Thus, the packet number counter is set to a previously unused value during initialization (or during periodic synchronization). Accordingly, nonces generated based on values of the packet number counter will not be re-used (e.g., because values of the packet number are not re-used) with a particular group key, thereby meeting a security requirement of at least one form of data encryption (e.g., CCMP encryption).

In another particular implementation, the packet number initialization scheme includes storing one or more packet number initialization values at a non-volatile memory. In this implementation, a device of the data link group may be configured to set a packet number to a particular value based on a packet number initialization value stored at a non-volatile memory of the device. To illustrate, the device may include a non-volatile memory configured to store data link group association data. The data link group association data includes security data, association data, and other information associated with the data link group, and with a group key of the data link group. For example, the data link group association data may include one or more sets of identifiers, a group key, and a packet number initialization value. The data link group association data may also be referred to as NDL group security association data or as mesh group temporal key security association (MGTKSA) data.

Upon joining a data link group, the device may receive a message from another device of the data link group. The message may include a group key associated with the data link group. If the device has joined the data link group for the first time during the lifetime of the group key (e.g., if the device has not previously joined the data link group during the lifetime of the particular group key), the device may store the data link group association data associated with the group key in the non-volatile memory. If the device has previously joined the data link group during the lifetime of the group key, the data link group association data may already be stored in the non-volatile memory.

The device may set a packet number counter to a particular value based on the packet number initialization value. For example, the particular value may be equal to the packet number initialization value (indicated by the message) plus one. After setting the packet number counter, the device may update (e.g., increment by a particular amount) the packet number initialization value at the non-volatile memory. The device may increment the packet number counter (e.g., in a volatile memory) as the device generates additional packets. In response to detecting that the packet number counter is within a threshold amount of the packet number initialization value stored at the non-volatile memory, the first device may update (e.g., increment by a particular amount) the packet number initialization value at the non-volatile memory to prevent the packet number counter from exceeding the packet number initialization value.

If the device leaves the data link group (e.g., due to disassociation, power-down, etc.), the packet number counter may be reset. However, the packet number initialization value remains stored in the non-volatile memory. The device may later re-join the data link group during the lifetime of the group key. After re-joining the data link group, the device receives another message including the group key. In response to determining that the group key corresponds to data link group association data stored at the non-volatile memory, the device may set a value of the packet number counter to a particular value based on the packet number initialization value included in the data link group association data. For example, the device may set the value of the packet number counter to be equal to the packet number initialization value plus one. As another example, the device may set the value of the packet number counter to be equal to the packet number initialization value. After the value of the packet number counter is set, the packet number initialization value is updated to prevent the packet number counter from being set to a value previously used as a packet number.

Setting the packet number to a particular value based on the packet number initialization value stored in the non-volatile memory may prevent packet number re-use at the device, due to the periodic (or continual) updating of the packet number initialization value. For example, the packet number initialization value may be updated after use in setting a value of the packet number counter or in response to detecting that the value of the packet number counter is close to the packet number initialization value. In this manner, the packet number counter will not be set to the same value multiple times during the lifetime of a particular group key using the packet number initialization value. Accordingly, nonces generated based on values of the packet number counter will not be re-used (e.g., because values of the packet number are not re-used) with a particular group key. Preventing re-use of nonces associated with a particular group key meets a security requirement of CCMP encryption. CCMP encryption may be specified for use in one or more wireless communication standards, such as an Institute of Electrical and Electronics Engineers (IEEE) 802.11 standard, a Wi-Fi Alliance standard, or another standard. Accordingly, devices that meet the security requirement of CCMP encryption may operate in accordance with one or more wireless communication standards.

Nonce re-use may potentially occur if a “wrap-around condition” (e.g., an “overflow condition”) occurs related to the packet number counter. For example, the packet number counter may store values having a particular number of bits (e.g., forty-eight bits). If the packet number counter is incremented a particular number of times (e.g., 2⁴⁸ times), the packet number counter may “wrap-around” or “overflow” to a value that has already been used. To illustrate, if the value of the packet number counter is initialized to a zero value (e.g., forty-eight zeroes) based on the TSF value at a first time, incrementing the packet number counter 2⁴⁸ times may cause the packet number counter to again store the zero value. As another example, incrementing the packet number initialization value stored at the non-volatile memory by a total amount that is greater than 2⁴⁸ may cause the packet number counter to store a previously-used value.

To prevent packet number re-use (and nonce re-use) with a particular group key, the device may be configured to determine whether an expiration condition associated with a group key (e.g., a temporal key) is satisfied based on a subset of bits of the TSF value or a packet number initialization value stored at the non-volatile memory. For example, in response to the device receiving a frame indicating the TSF value (or in response to the device generating the TSF value if the device is operating as an anchor master device), the device may compare a subset of bits of the TSF value to a threshold (e.g., an expiration threshold). The subset of bits includes the same number of bits as the packet number counter. If the subset of bits exceeds the threshold, the expiration condition is satisfied. For example, the device may compare the subset of bits to a particular value (e.g., the expiration threshold), such as a value that is one less than a value associated with the wrap-around condition or a different value that is less than the value associated with the wrap-around condition, and the if the value exceeds the particular value, the expiration condition is satisfied. As another example, the device may detect that a value of a set of bits of the packet number initialization value is equal to or exceeds a particular value (e.g., the expiration threshold). The particular value may be a particular amount less than the value associated with the wrap-around condition. If the value of the set of bits is equal to or exceeds the particular value, the expiration condition is satisfied. In response to the expiration condition being satisfied, the device may perform one or more group key expiration actions to prevent nonce re-use with a particular group key. For example, the device may initiate generation of a second group key. As another example, the device may initiate a tear down operation for the data link group.

Thus, a system that prevents re-use of packet numbers, and therefore prevents re-use of nonces with a particular group key, is disclosed. For example, because devices of the data link group are configured to set a value of a packet number counter to a particular value based on the TSF value or based on a packet number initialization value stored at a non-volatile memory, packet numbers may not be repeated (e.g., re-used) for a group key. Because packet numbers are not repeated, nonces generated based on the packet numbers may not be repeated (e.g., re-used) for use with a particular group key. Preventing nonce re-use with a particular group key enables devices of the data link group to meet security criteria of at least one encryption protocol, such as CCMP encryption. Meeting the security criteria of the encryption protocol enables devices of the data link group to operate in accordance with one or more wireless communication standards, such as an IEEE 802.11 standard, a Wi-Fi Alliance standard, or another wireless communication standard.

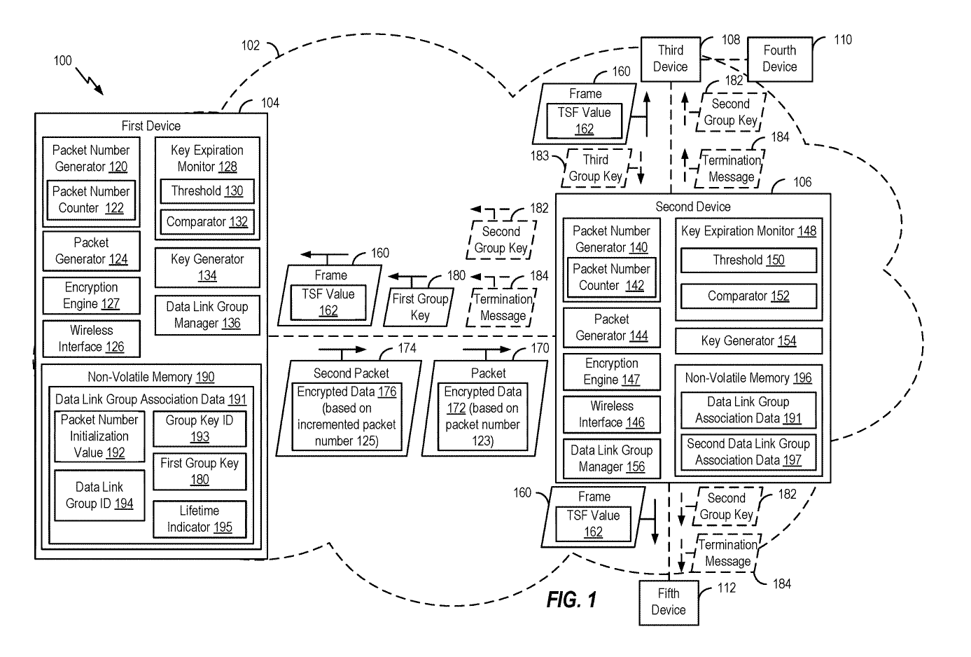

Referring to FIG. 1, a block diagram of a system that prevents nonce re-use with a particular group key at devices of a data link group of a neighbor aware network (NAN) is shown and generally designated 100. The system 100 includes a wireless network 102, such as a NAN or a wireless mesh network, that supports transmission of messages that are encrypted based on packet numbers, the packet numbers determined in accordance with one or more packet number initialization schemes of one or more data link groups. The wireless network 102 may also include one or more data link groups. For example, one or more devices of the wireless network 102 may be included in one or more data link groups that support transmission of messages that are encrypted based on packet numbers.

The wireless network 102 may include a first device 104, a second device 106, a third device 108, a fourth device 110, and a fifth device 112. The wireless network 102 (and the system 100) is illustrated for convenience only and is not limiting. For example, in other implementations, the wireless network 102 may include more devices or fewer devices than illustrated in FIG. 1, and the devices may be located at different locations than illustrated in FIG. 1. Each of the devices 104-112 may be a wireless communication device configured to transmit data and to receive data from one or more other wireless communication devices included in the wireless network 102. Each of the devices 104-112 may be a fixed location electronic device or a mobile electronic device. For example, the devices 104-112 may include or correspond to mobile phones, laptop computers, tablet computers, personal computers, computerized watches, multimedia devices, peripheral devices, data storage devices, a vehicle or components thereof (e.g., control display unit of a vehicle, as a non-limiting example), or a combination thereof. Additionally or alternatively, each of the devices 104-112 may include a processor, such as a central processing unit (CPU), a digital signal processor (DSP), a network processing unit (NPU), etc., a memory, such as a random access memory (RAM), a read-only memory (ROM), etc., and a wireless interface 126 (or a wireless interface 146) configured to send and receive data via one or more wireless networks or wireless communication channels. The wireless interface 126 (or the wireless interface 146) may interface with a receiver, a transmitter, or both. Although certain operations described herein may be described with reference to a “receiver” or a “transmitter,” in other implementations a transceiver may perform both data receiving and data transmitting operations.

The devices 104-112 may be configured to exchange data, services, or a combination thereof, via one or more wireless networks. As used herein, a transmission “via” a wireless network may include, but is not limited to, a “point-to-point” transmission between two devices of the wireless network 102. As another example, a transmission via the wireless network 102 may include a communication that is “broadcast” (e.g., transmitted) from a particular device of the wireless network 102 to multiple other devices of the wireless network 102. The wireless network 102 may be an infrastructure network or an infrastructure-less network, such as a peer-to-peer network (e.g., an ad hoc network). The devices 104-112 may be configured to operate in accordance with one or more wireless protocols and/or standards, such as an Institute of Electrical and Electronics Engineers (IEEE) 802.11 standard. For example, the devices 104-112 may operate in accordance with an IEEE 802.11a, b, g, n, s, aa, ac, ad, ae, af, ah, ai, aj, aq, ax, or mc standard. Additionally, the devices 104-112 may operate in accordance with one or more neighbor aware network (NAN) standards or protocols, such as a Wi-Fi Alliance standard as an illustrative, non-limiting example.

One or more of the devices 104-112 may be configured to communicate with a cellular network via one or more cellular communication protocols and/or standards, such as a code division multiple access (CDMA) protocol, an orthogonal frequency division multiplexing (OFDM) protocol, an orthogonal frequency division multiple access (OFDMA) protocol, a time division multiple access (TDMA) protocol, a space division multiple access (SDMA) protocol, etc. Additionally, one or more of the devices 104-112 may be configured to operate in accordance with one or more near-field communications standards, such as a Bluetooth® standard (Bluetooth is a registered trademark of Bluetooth SIG, Inc.). One or more of the devices 104-112 may exchange data via infrared or other near-field communications.

In a particular implementation, the devices 104-112 are configured to perform data communications via the wireless network 102 (e.g., a neighbor aware network (NAN)). The wireless network 102 may operate in accordance with one or more standards or protocols, such as an IEEE standard or a Wi-Fi Alliance standard, as non-limiting examples. The devices 104-112 may be configured to perform data exchanges via wireless communications between the devices 104-112 (e.g., other devices of the wireless network 102). For example, each of the devices 104-112 may include or correspond to a station, such as a wireless station or a wireless communication device, of the wireless network 102. The data exchanges may be performed without involving wireless carriers, access points (APs), and/or the Internet.

Each of the devices 104-112 may enter and exit the wireless network 102 (e.g., the NAN) at various times during operation. For example, a device that is not within the wireless network 102 may detect a discovery beacon (or other NAN beacon) and may associate with the wireless network 102 during a discovery window identified by the discovery beacon, in accordance with a NAN standard or protocol. Additionally, the devices 104-112 may disassociate from the wireless network 102 at any time. While within the wireless network 102, the devices 104-112 may be configured to transmit or to receive messages indicating an availability to communicate via one or more logical channels. For example, the devices 104-112 may be configured to transmit or to receive service advertisements. The service advertisements may include or correspond to service discovery frames (SDFs). The service advertisements may advertise a service provided via one or more logical channels by at least one device of the wireless network 102. As used herein, a “logical channel” may refer to a particular wireless communication channel (e.g., a 2.4 gigahertz (GHz) channel or a 5 GHz channel, as non-limiting examples) and one or more time periods (e.g., “time blocks”) designated for communication via the particular wireless communication channel.

While within the wireless network 102, the devices 104-112 may be configured to transmit synchronization beacons to, or to receive synchronization beacons from, one or more other devices of the wireless network 102. A synchronization beacon may indicate synchronization information and may be formed in accordance with one or more NAN standards or protocols. Each of the devices 104-112 may be configured to synchronize a respective internal clock based on the synchronization beacons. The synchronization beacons may be retransmitted (e.g., rebroadcast) by some of the devices 104-112 within the wireless network 102, in accordance with a NAN standard or protocol, to enable the synchronization beacons to reach other devices that are beyond a wireless communication range of the device that transmits the synchronization beacon. In a particular aspect, the synchronization beacons may be transmitted between devices of the wireless network 102 via a first wireless channel, such as a “NAN channel.” As referred to herein, a “NAN channel” is a particular wireless channel that is reserved for devices to perform NAN discovery operations and NAN synchronization operations. As used herein, the “NAN channel” corresponds to the wireless network 102, and communications in the wireless network 102 may be performed via the NAN channel.

In addition to being included in the wireless network 102, one or more of the devices 104-112 may be included in one or more “data link groups.” A data link group may also be referred to as a data link, a NAN data link (NDL), a data link network, a group network, a NAN data link (NDL) network, a data path group, a data path group network, a NAN data path, or a NAN data path group network. In some implementations, the data link group may include a mesh network, such as a “social Wi-Fi mesh network,” as an illustrative, non-limiting example. The data link group may include multiple devices that are able to form a network, such as a decentralized wireless network. Each device of the data link group may share a type of data announcement and may use shared security credentials. For example, security information, such as group keys or common network keys, may be shared between the devices in the data link group using wireless communications that are in band or out of band with respect to the data link group.

A data link group may correspond to a service provided via a particular logical channel by one of the devices 104-112. For example, in FIG. 1, the first device 104 may provide a particular service, such as a music service, a gaming service, a social media, an advertising service, a message sharing service, etc., via the particular logical channel to other devices in a data link group. The particular logical channel may represent a communication schedule of the data link group. For example, the particular logical channel may indicate times and via which wireless devices of the data link group are available to communicate. As another example, the first device 104 may be part of another network, such as an access point (AP) based network or an independent basic service set (IBSS) network, and the first device 104 may be configured to advertise the other network to enable other devices of the wireless network 102 to join the other network via the first device 104. In some implementations, the devices of the data link group may be synchronized (via timing information in messages, such as NAN beacons or synchronization messages) to have periodic wake-up times. As one example, each device of the data link group may operate in an active operating mode during one or more paging windows to advertise a service and/or to receive traffic or other messages. If a device does not receive an indication of pending traffic, the device may transition to a low-power operating mode (e.g., a “sleep” mode) during other time periods (e.g., transmission windows) to conserve power.

The data link groups may include “single-hop” data link groups, “multi-hop” data link groups, or a combination thereof. A single-hop data link group may include one or more devices that are within a wireless communication range (e.g., distance) of a provider, such as a device that provides a service. A multi-hop data link group may include one or more devices that are outside a wireless communication range of the provider. In the multi-hop data link, at least one device may receive a message (including data) from the provider and may rebroadcast the message to another device that outside of the wireless communication range of the provider. In a particular implementation, the data link group illustrated in FIG. 1 may be a multi-hop data link group that includes the devices 104-112. In this implementation, wireless communications from the first device 104 to the fourth device 110 may be routed (or retransmitted) by the third device 108. In another particular implementation, the data link group of the wireless network 102 may be a single-hop data link group that includes the devices 104, 106, 108, and 112. The fourth device 110 may not be included in the single-hop data link group because the fourth device 110 is not within a wireless communication range (e.g., a one-hop range) of the first device 104.

One or more of the devices 104-112 may be configured to provide a service, such as by operating as a provider device. For example, the second device 106 may be configured to operate as a data source. The second device 106 may transmit data to other devices, such as subscriber devices, of the data link group. For example, to share a music service, the second device 106 may transmit music data to another device in the data link group. As another example, to share a social media service, the second device 106 may transmit text data, score data, image data, video data, or a combination thereof, to another device in the data link group. The other devices (e.g., the subscriber devices) may be configured to operate as data sinks.

In a particular implementation, the data may be transmitted between devices of the data link group via a second wireless channel, such as a “data link group” channel. As used herein, a “data link group channel” is a particular wireless channel that is reserved for devices in a corresponding data link group to communicate messages (e.g., service messages, paging messages, etc.) regarding sharing a service and to communicate data related to the service. The data link group channel may also be referred to as an NDL channel. A logical channel may correspond to (or represent) a data link group channel and one or more transmission windows (e.g., time blocks), such as a set of transmission windows. For example, while devices are communicating “via a logical channel,” data may be transmitted between devices of the data link group via the data link group channel during the one or more transmission windows. The data link group channel may be used for sharing security information, for performing association operations, and for performing routing operations (in multi-hop data link groups), or a combination thereof.

In some implementations, the data link group channel and the NAN channel may be different wireless channels that correspond to different wireless frequency bands. The NAN channel, the data link group channel, or both, may be specified in one or more wireless standards, such as a Wi-Fi Alliance standard as a non-limiting example. In a particular implementation, the NAN channel may be a 2.4 GHz channel, and the data link group channel may be a 5 GHz channel. In an alternate implementation, the data link group channel and the NAN channel may be the same wireless channel. For example, one or more of the devices 104-112 may share data with devices of the data link group via the NAN channel. In some implementations, the wireless network 102 (e.g., the NAN) may include multiple data link groups, and each of the multiple data link groups may correspond to a distinct data link group channel. The multiple data link groups may correspond to different services provided by different devices in the wireless network 102. In other implementations, devices of the multiple data link groups may share data via the wireless network 102, such as via the NAN channel. In some implementations, devices of the multiple data link groups may share data via the same data link group channel during distinct transmission windows.

The devices 104-112 may include one or more components configured to enable communication via the data link group, via the wireless network 102, or both. As illustrated in FIG. 1, the first device 104 may include a packet number generator 120, a packet generator 124, an encryption engine 127, the wireless interface 126, a key expiration monitor 128, a key generator 134, a data link group manager 136, and a non-volatile memory 190. The second device 106 may include a packet number generator 140, a packet generator 144, an encryption engine 147, the wireless interface 146, a key expiration monitor 148, a key generator 154, a data link group manager 156, and a non-volatile memory 196. Operations described with reference to components 120, 124, 126, 127, 128, 134, 136, or 190 of the first device 104 may also be performed by components 140, 144, 146, 147, 148, 154, 156, or 196, respectively, of the second device 106, and operations described with reference to components 140, 144, 146, 147, 148, 154, 156, or 196 of the second device 106 may also be performed by the components 120, 124, 126, 127, 128, 134, 136, or 190, respectively, of the first device 104. Additionally or alternatively, each of the devices 104-112 may include a processor coupled to a memory and configured to perform the operations of the above-referenced components. For example, the memory may include computer-readable instructions that, when executed by the processor, cause the processor to perform the operations of the above-referenced components described herein.

In a particular implementation, the second device 106 may be configured to operate as an “anchor master” device of the wireless network 102. As used herein, an anchor master device refers to a device that performs operations to generate timing information, synchronization information, other upkeep information related to the wireless network 102, or a combination thereof. For example, the second device 106 may be configured to generate frames, such as the frame 160. The frame 160 may include timing information and other information related to synchronization and upkeep of the wireless network 102. The second device 106 may transmit the frame 160 to other devices of the wireless network 102, such as the first device 104, the third device 108, and the fifth device 112. The frame 160 may include a timing synchronization function (TSF) value 162. The TSF value 162 may indicate a time determined by an anchor master device of the wireless network 102. For example, the TSF value 162 may indicate a time determined based on an internal clock of the second device 106. The TSF value 162 may be incremented by the second device 106 according to a particular rate. In a particular implementation, the TSF value 162 is incremented once per microsecond (μs). In other implementations, the TSF value 162 is incremented faster or slower than once per μs. One or more wireless communication standards, such as a NAN standard, may specify the rate at which the TSF value 162 is incremented.

In other implementations, the second device 106 may operate as a “master device” or a “sync master” device. As used herein, a master device (or a sync master device) refers to a device of the wireless network 102 that is designated to forward received beacons or sync messages to other devices of the wireless network 102, such as devices that are outside of a one-hop range of the anchor master device. For example, the second device 106 may receive the frame 160 from a device that is operating as the anchor master device (or another master device or sync master device), and the second device 106 may route (e.g., retransmit) the frame 160 to the first device 104, the third device 108, and the fifth device 112.

The first device 104 may be configured to receive the frame 160 and to use the frame 160 to perform operations related to the data link group, the wireless network 102, or both. The devices of the data link group, the wireless network 102 (e.g., the NAN), or both may be configured to encrypt and decrypt data in conformance with one or more encryption protocols specified by a wireless standard. For example, IEEE 802.11s specifies that data is to be encrypted using Counter mode with Cipher-block chaining Message authentication code protocol (CCMP) encryption. CCMP encryption may use group keys (e.g., temporal keys) and packet numbers, as well as other information, to encrypt data. As used herein, a group key refers to a common network key that is distributed to devices of a data link group and used to encrypt data for transmission to one or more devices of the data link group, to decrypt data received from one or more devices of a data link group, or both. Group keys may also be referred to as temporal keys because a group key may be associated with a validity time period (e.g., the group key may become invalid after a validity time period).

The first device 104 may be configured to generate packet numbers for use in encrypting data to be transmitted to other devices of the data link group. In order to encrypt (or decrypt) data, the first device 104 may set a packet number to a particular value in accordance with a packet number initialization scheme of the data link group. In a particular implementation, the packet number initialization scheme corresponds to group-addressed traffic, such as traffic (e.g., data transmissions) that are intended for more than one device of the data link group. In other implementations, the packet number initialization scheme may correspond to other types of traffic in addition to, or in alternative to, group-addressed traffic. In a particular implementation, the packet number initialization scheme includes setting one or more packet numbers based on one or more TSF values. To illustrate, the first device 104 may use information in the frame 160, such as the TSF value 162, to set the packet number to a particular value, and the packet number may be used to encrypt data. As an example, the packet number may be set (e.g., determined) based on a result of an operation, such as a modulo operation, that is performed on the TSF value 162. In another particular implementation, the packet number initialization scheme includes storing one or more packet number initialization values at the non-volatile memory 190 of the first device 104. To illustrate, the first device 104 may use information stored in the non-volatile memory 190 to set the packet number to a particular value, and the packet number may be used to encrypt data. For example, the packet number may be used to generate a nonce, and data may be encrypted based on the nonce, in accordance with one or more data encryption techniques, as further described herein. The packet number may be set (e.g., initialized) by the first device 104 in response to joining the wireless network 102 or in response to rejoining the wireless network 102 after disassociating from the wireless network 102. In a particular implementation, the packet number may be set to a non-zero value based on the TSF value 162 or based on a packet number initialization value stored at the non-volatile memory 190. In other implementations, the packet number may be set to a different value based on the TSF value 162 or based on the packet number initialization value. After the packet number is set, the packet number may be incremented after generation of a data packet, as further described herein. Additionally or alternatively, the packet number may be set (e.g., re-initialized) periodically during operation of the first device 104. In a particular implementation, the encryption may be CCMP encryption. A security requirement of CCMP encryption includes preventing re-use of nonces with a particular group key used to encrypt data.

To illustrate, data may be encrypted based on a nonce and a group key. As used herein, a nonce refers to a number or a string of bits or other symbols. The nonce may be generated based on the packet number and a media access control (MAC) address of the transmitting device (e.g., the first device 104). If two nonces are generated the same MAC address and the same packet number, the two nonces will be the same. Using the same nonce (e.g., “re-using” a nonce) and the same group key to encrypt two different packets of data violates a security criterion of CCMP encryption. Thus, to prevent nonce re-use (and to operate in accordance with the security criteria of CCMP encryption) with a particular group key, the devices 104-112 may be configured to prevent packet number re-use, as further described herein.

The first device 104 includes the packet number generator 120. The packet number generator 120 may be configured to generate or set a packet number for use in encrypting data to be transmitted to devices of the data link group. To illustrate, the packet number generator 120 may include a packet number counter 122 that is configured to maintain a value of a packet number. The packet number generator 120 may be configured to set a value of the packet number counter 122. The packet number generator 120 may be configured to set the value of the packet number counter 122 as part of an initialization process. To illustrate, after being powered on, the first device 104 may detect a power-on event. The first device 104 may monitor a wireless network associated with the data link group (e.g., the data link group channel) for one or more messages after detecting the power-on event, and the first device 104 may receive the frame 160. Additionally or alternatively, the first device 104 may be configured to periodically update the value of the packet number counter 122. The packet number generator 140 of the second device 106 may include a packet number counter 142 that is configured similarly to the packet number counter 122.

In a particular implementation, the packet number generator 120 may be configured to set a packet number to a particular value based on the TSF value 162 included in the frame 160. The TSF value 162 may be a 64-bit value and the packet number may be a 48-bit value, and the particular value may include a result of a modulo (%) operation performed on the TSF value 162 by 2⁴⁸. Alternatively, the TSF may be more bits or fewer bits than 64, the packet number may be more bits or fewer bits than 48, and the particular value may include a result of a different modulo function or a different operation. Because the packet number counter 122 is set to a particular value based on the TSF value 162, instead of being initialized to zero, the packet number counter 122 may be prevented from being set to a value that has already been used as a packet number. Thus, re-use of packet numbers is avoided, which may satisfy a security criterion of at least one encryption protocol.

In another particular implementation, the packet number generator 120 may be configured to set a packet number to a particular value based on a packet number initialization value stored at the non-volatile memory 190. The packet number initialization value may be included in data link group association data that is stored at the non-volatile memory 190. The packet number initialization value may be periodically (or continually) updated, as further described herein, such that the value of the packet number counter 122 does not exceed the packet number initialization value. Because the packet number counter 122 is set to a particular value based on the packet number initialization value, the packet number counter 122 may be prevented from being set to a value that has already been used as a packet number. Thus, re-use of packet numbers is avoided, which may satisfy a security criterion of at least one encryption protocol.

In this particular implementation, the device may be configured to receive a group key as part of (or after) a process of joining a data link group. The device may be configured to determine if data link group association data associated with the group key is stored at a non-volatile memory. If data link group association data associated with the group key is stored at the non-volatile memory, the device may set a value of the packet number counter 122 to a particular value based on a packet number initialization value stored in the data link group association data. If data link group association data associated with the group key is not stored at the non-volatile memory (e.g., if the device has not previously joined the data link group during the lifetime of the group key), the device may generate and store data link group association data associated with the group key at the non-volatile memory.

For example, in FIG. 1, the first device 104 may associate with the second device 106 to join the data link group for a first time. In response to joining the data link group, the first device 104 may receive one or more messages from the second device 106, such as the frame 160 or a message that includes or indicates a group key, such as a first group key 180, that is used by devices of the data link group to encrypt and decrypt data. In response to receiving the first group key 180, the packet number generator 120 of the first device 104 may be configured to determine whether data link group association data associated with the first group key 180 is stored at the non-volatile memory 190. In response to determining that data link group association data associated with the first group key 180 is stored at the non-volatile memory 190, the packet number generator 120 may set the packet number counter 122 to a particular value based on the data link group association data (e.g., based on a packet number initialization value included in the data link group association data). In response to determining that data link group association data associated with the first group key 180 is not stored at the non-volatile memory 190, the first device 104 may generate data link group association data associated with the first group key 180 and store the data link group association data at the non-volatile memory 190.

For example, in response to determining that there is no data link group association data stored at the non-volatile memory 190 that is associated with the first group key 180, the first device 104 may generate data link group association data 191 that is associated with the first group key 180. The data link group association data 191 may include a packet number initialization value 192. The packet number initialization value 192 may be a particular value that is designated for use by devices of the data link group. The packet number initialization value 192 may be initialized during a previous association with the data link group and maintained at the non-volatile memory 190. If the device has not previously joined the data link group during the lifetime of the first group key 180, the packet number initialization value 192 may be set to an initial value. In some implementations, the initial value may be a particular value that stored or pre-programmed at the first device 104 (e.g., during manufacture or production). Alternatively, the initial value may be indicated by a message from another device of the data link group (e.g., the threshold value may be associated with the data link group). In a particular implementation, the initial value is a non-zero value. In other implementations, the initial value may be another value. The data link group association data 191 may include other information in addition to the packet number initialization value 192. For example, the data link group association data 191 may include a group key identifier 193 that identifies the first group key 180, a data link group identifier 194 that identifies the data link group, the first group key 180, a lifetime indicator 195 that indicates a lifetime of the first group key 180, or a combination thereof. The first device 104 may be configured to store the data link group association data 191 at the non-volatile memory 190.

The packet number generator 120 may set a value of the packet number counter 122 to a particular value based on the packet number initialization value 192. As a particular example, the packet number generator 120 may set a value of the packet number counter 122 to be equal to the packet number initialization value 192 plus one. As another example, the packet number generator 120 may set a value of the packet number counter 122 to be equal to the packet number initialization value 192. After setting the value of the packet number counter 122, the first device 104 may be configured to update (e.g., increment) the packet number initialization value 192 to prevent the value of the packet number counter 122 from exceeding the packet number initialization value 192 (and to prevent packet number re-use from occurring). For example, the first device 104 may be configured to increment the packet number initialization value 192 by a particular increment value (N). As one example, the particular increment value N may be equal to one million (e.g., the first device 104 may increment the packet number initialization value by one million). In other examples, the particular increment value N may be more than one million or less than one million. The particular increment value N may be selected to reduce the number of write operations to the non-volatile memory 190, which may increase performance and reduce wear to the non-volatile memory 190. In some implementations, the particular increment value N may be indicated by a message received from another device of the data link group, such as the frame 160 or a message that includes the first group key 180. In an alternative implementation, the packet number initialization value 192 may be updated in response to incrementing the packet number counter 122. In another implementation, the packet number initialization value 192 may be updated periodically (e.g., after a fixed amount of time).

Because the packet number initialization value 192 is stored at the non-volatile memory 190, the packet number initialization value 192 may be maintained after the first device 104 disassociates from the data link group or powers down. For example, a user of the first device 104 may power down the first device 104 at a particular time. At a later time, the first device 104 may be powered on and may rejoin the data link group. Upon rejoining the data link group (and receiving a message that indicates the first group key 180), the first device 104 may be configured to determine whether data link group association data associated with (e.g., corresponding to) the first group key 180 is stored at the non-volatile memory 190. In this example, because the first device 104 previously joined the data link group during the lifetime of the first group key 180, the data link group association data 191 has been stored in the non-volatile memory 190. In response to determining that the data link group association data 191 corresponds to the first group key 180, the packet number generator 120 of the first device 104 may access the data link group association data 191 and set the packet number counter 122 to a particular value based on the packet number initialization value 192.

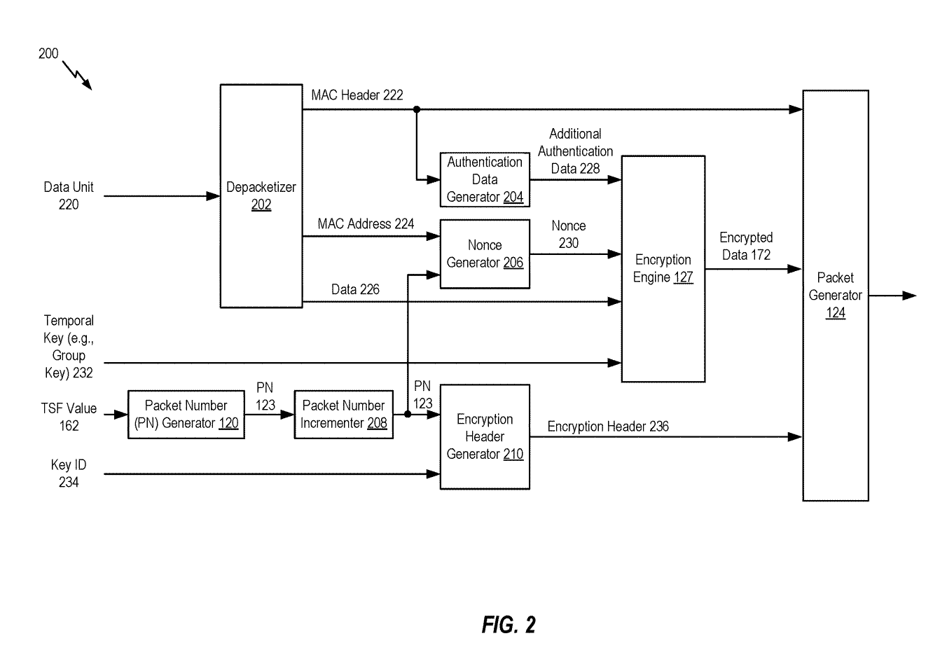

The encryption engine 127 may be configured to encrypt data to be included in a packet based on a packet number (e.g., a value of the packet number counter 122). In a particular implementation, the encryption engine 127 may be configured to encrypt data based on a nonce (that is generated based on the packet number) and a group key. The group key may be shared by devices of the data link group and may be used to encrypt messages. The first device 104 may include a nonce generator, as further described with reference to FIG. 2, that is configured to generate a nonce based on a packet number and a MAC address of the transmitting device (e.g., the first device 104). In a particular implementation, the encryption engine 127 is configured to perform CCMP encryption. In other implementations, the encryption engine 127 may be configured to perform encryption using other encryption protocols. The encryption protocols used by the encryption engine 127 may be specified in one or more wireless communication standards, such as an IEEE 802.11s standard, as a non-limiting example.

The packet generator 124 may be configured to generate a packet for transmission to other devices of the data link group. The packet may include data encrypted by the encryption engine 127. The wireless interface 126 may be configured to transmit the packet to at least one device of the data link group. The first device 104 may also include a packet incrementer, as further described with reference to FIG. 2, that is configured to increment the packet number counter 122 after generation (or transmission) of the packet. For example, after generation of a packet, the packet incrementer may increment the packet number counter 122. In a particular implementation, the packet number counter 122 may be configured to be incremented at a rate that is less than or equal to a rate of increment of the TSF value 162. In this implementation, because the packet number counter 122 is incremented at a rate that is less than or equal to the rate of increment of the TSF value 162, a rate of the number of packet transmissions may be less than or equal to the rate of increment of the TSF value 162.

Additionally or alternatively, the packet number initialization value 192 stored at the non-volatile memory 190 may be periodically (or continually) updated such that the value of the packet number counter 122 does not exceed the packet number initialization value 192. As described above, the packet number counter 122 may be incremented after generation of a data packet. The first device 104 may be configured to determine whether a difference between the value of the packet number counter 122 and the packet number initialization value 192 is less than (or equal to) an update threshold. The first device 104 may be further configured to update the packet number initialization value 192 in response to determining that the value of the difference is less than (or equal to) the update threshold. The update threshold may be selected such that the first device 104 has sufficient time to update the packet number initialization value 192 prior to the packet number counter 122 reaching the value of the packet number initialization value 192 (e.g., prior to potential packet number re-use). In some implementations, the update threshold may be indicated by a message received from another device of the data link group, such as the frame 160 or a message that includes the first group key 180. As described above, the packet number initialization value 192 may be incremented by the particular increment value N. Alternatively, the first device 104 may be configured to increment the packet number initialization value 192 in response to the packet number counter 122 being incremented.

Packet number initialization in this manner prevents each device of the data link group from encrypting two different packets using the same packet number and the same group key. The packet number generator 120 may generate an incremented packet number based on the packet number counter 122 in response to determining that a next packet is to be generated, and data for inclusion in the next packet may be encrypted based on the incremented packet number and the group key. In this manner, data in different packets is encrypted based on different packet numbers (e.g., different nonces), which satisfies a security criterion of at least one encryption protocol.

The devices of the data link group may also be configured to monitor the TSF value 162 or the packet number initialization value 192 and to perform one or more operations to prevent packet number re-use based on the TSF value 162 or based on the packet number initialization value 192. Although the second device 106 is described as performing monitoring and packet number re-use prevention actions, such description is for convenience, and any of the devices 104-112 may be similarly configured to perform similar actions. For example, components 128-136 and 190 of the first device 104 may be similarly configured to the components 148-156 and 196 of the second device 106, as described herein.

The key expiration monitor 148 may be configured to determine whether an expiration condition associated with the first group key 180 of the data link group is satisfied based on a subset of bits of the TSF value 162 or based on the packet number initialization value 192 (of the data link group association data 191) stored at the non-volatile memory 196. The key expiration condition may indicate that a lifetime of the data link group exceeds a threshold value. In a first particular implementation, the key expiration monitor 148 may be configured to compare a value of the subset of bits of the TSF value 162 to a threshold 150 (e.g., an expiration threshold) and to determine whether the value of the subset of bits exceeds the threshold 150. For example, the key expiration monitor 128 may include a comparator 152 configured to compare the subset of bits of the TSF value 162 to the threshold 150.

In a particular implementation, the subset of bits of the TSF value 162 may be the 48 least-significant bits (LSBs), such that the subset of bits is the same size as the packet number (e.g., 48 bits). In this implementation, after a particular value of the subset of bits (e.g., a value where each bit is a logical one value) is incremented, each bit of the subset of bits having the incremented value may be a logical zero value. Such a value (e.g., 48 bits that are each a logical zero value) may be the same as an initial value of the subset of bits. Thus, after the particular value is incremented, the subset of bits of the TSF value 162 used to generate a packet number may have the same value as an initial value, which may cause re-use (e.g., repetition) of packet numbers. In a particular implementation, the subset of bits includes 48 bits and the TSF value is incremented once per microsecond. In this implementation, a duration of time from the TSF value 162 having an initial value to at which the TSF value 162 returns to the initial value (e.g., due to “wrap-around” or “overflow”) may be approximately 8.9 years. Thus, if a 48-bit packet counter is used and the TSF value 162 is incremented once per microsecond, a group key may be used for approximately 8.9 years before a possibility of packet number re-use occurs.

An expiration condition of a group key may therefore correspond to the subset of bits of the TSF value 162 having a particular value. The expiration condition may be detected in various ways. As one example, the comparator 152 may compare the subset of bits (e.g., the 48 LSBs) of the TSF value 162 to the particular value (e.g., 48 bits each having a logical one value). If the value of the subset of bits is equal to the particular value, the expiration condition may be detected. However, problems may occur if the TSF value 162 is not transmitted every microsecond, or if a device does not receive the transmission with the TSF value 162 having the particular value. Accordingly, the particular value may be set to a value that is less than the last value before re-use occurs (e.g., 48 bits each having a logical one value, in a particular implementation). For example, a first group of bits of the particular value may have a first state (e.g., a logical one value), and a second group of bits of the particular value may have a second state (e.g., a logical zero value). As one particular example, the 10 LSBs of the particular value may be logical zero values, and the remaining 38 bits may be logical one values. Other values may be selected based on a target duration of time between detection of the expiration condition and potential re-use of packet numbers. Thus, the particular value (e.g., the threshold 150) may be selected to provide sufficient time between detection of the expiration condition and potential packet number re-use to enable one or more operations to be performed, such as distribution of a new group key or tear-down of the data link group (or the wireless network 102), as further described herein. In another particular implementation, detection of the expiration condition may be determined based on a value of a particular bit of the TSF value 162. For example, if the packet number is a 48-bit value, the expiration condition may correspond to the 49th LSB of the TSF value 162 being incremented from a first value (e.g., a logical zero value) to a second value (e.g., a logical one value).

In a second particular implementation, the key expiration monitor 148 may be configured to compare a value of a set of bits of the packet number initialization value 192 (of the data link group association data 191) stored at the non-volatile memory 196 to the threshold 150 (e.g., the expiration threshold) and to determine whether the value of the set of bits is equal to or exceeds the threshold 150. For example, the key expiration monitor 148 may include the comparator 152 configured to compare the set of bits of the packet number initialization value 192 to the threshold 150. The threshold 150 may be a value that is less than a maximum value capable of being stored by the packet number initialization value 192. For example, the packet number initialization value 192 may be a 48-bit value, and the threshold 150 (e.g., the expiration threshold) may be a value that is less than a value indicated by 48 one values. Determining that the packet number initialization value 192 is equal to or exceeds the threshold 150 indicates that the packet number initialization value 192 is nearing a wrap-around condition. The threshold 150 (e.g., the expiration threshold) may be selected such that a difference between the threshold 150 and the maximum value is sufficient to enable one or more expiration condition operations to be performed prior to the packet number initialization value 192 being incremented beyond the maximum value. Incrementing the packet number initialization value 192 beyond the maximum value may cause a wrap-around or overflow condition, which may result in packet numbers being re-used for the same group key. The key expiration monitor 128 of the first device 104 may include a comparator 132 configured to compare a set of bits of the packet number initialization value 192 to a threshold 130 (e.g., a second expiration threshold), in a similar manner to the comparator 152 and the threshold 150.

An expiration condition of a group key may therefore correspond to the set of bits of the packet number initialization value 192 having (or exceeding) a particular value (e.g., the expiration threshold). The expiration condition may be detected in various ways. As one example, the comparator 152 may compare the set of bits of the packet number initialization value 192 to the particular value (e.g., 48 bits each having a logical one value). If the value of the set of bits is equal to the particular value, the expiration condition may be detected. However, problems may occur if the packet number initialization value 192 is incremented by more than one (e.g., a wrap-around condition may occur). Accordingly, the particular value (e.g., the threshold 150), also referred to as the expiration threshold, may be set to a value that is less than the last value before re-use occurs (e.g., 48 bits each having a logical one value, in a particular implementation). For example, a first group of bits of the particular value may have a first state (e.g., a logical one value), and a second group of bits of the particular value may have a second state (e.g., a logical zero value). As one particular example, the 10 LSBs of the particular value may be logical zero values, and the remaining 38 bits may be logical one values. Other values may be selected based on a target duration of time between detection of the expiration condition and potential re-use of packet numbers. Thus, the particular value (e.g., the threshold 150) may be selected to provide sufficient time between detection of the expiration condition and potential packet number re-use to enable one or more operations to be performed, such as distribution of a new group key or tear-down of the data link group (or the wireless network 102), as further described herein. In another particular implementation, detection of the expiration condition may be determined based on a value of a particular bit of the packet number initialization value 192. For example, if the packet number is a 48-bit value, the expiration condition may correspond to the 47th LSB of the packet number initialization value 192 being incremented from a first value (e.g., a logical zero value) to a second value (e.g., a logical one value).

The second device 106 includes the data link group manager 156 configured to initiate a group key expiration action in response to the expiration condition being satisfied. The group key expiration action may include one or more actions that prevent packet number re-use for a particular group key. As one example, the group key expiration action may include initiating a tear down operation for the data link group in response to the expiration condition being satisfied. In a particular implementation, the tear down operation includes marking the first group key 180 as invalid in a memory of devices of the data link group. In another particular implementation, the wireless interface 146 is configured to transmit a termination message 184 to other devices of the data link group. Alternatively, other tear down operations may be performed.

As another example, the group key expiration action may include generating a second group key of the data link group. To illustrate, the second device 106 may include the key generator 154 configured to initiate generation of a second group key 182 of the data link group in response to the expiration condition being satisfied. The second group key 182 may be distributed to devices of the data link group and used to encrypt messages for transmission to, or to decrypt messages received from, devices of the data link group. Nonces may be re-used with different group keys (e.g., temporal keys) without violating a security criterion of CCMP encryption. For example, a particular nonce and a first group key may be used to encrypt a first data packet, and the particular nonce and a second group key may be used to encrypt a second data packet without violating a security criterion of CCMP encryption. Tearing down the data link group (or the wireless network 102), or distributing a new group key (e.g., the second group key 182) may prevent packet number re-use with a particular group key at devices of the data link group.

During operation, the second device 106 may generate the frame 160 in accordance with a NAN standard or protocol. The frame 160 may include or correspond to a NAN beacon message or a synchronization (sync) message. The second device 106 may transmit the frame 160 to devices of the wireless network 102 within a one-hop range of the second device 106. For example, the second device 106 may transmit the frame 160 to the first device 104, the third device 108, and the fifth device 112. The third device 108 may route (e.g., retransmit) messages, such as the frame 160, from the second device 106 to the fourth device 110. The frame 160 may include the TSF value 162. The second device 106, if operating as an anchor master device for the wireless network 102, may determine the TSF value 162 based on an internal clock of the second device 106. In a particular implementation, the TSF value 162 is a 64-bit value that is incremented once per μs. In other implementations, the TSF value 162 may be other sizes, the TSF value 162 may be incremented at other rates, or both. A size and a rate of increment of the TSF value 162 may be specified in a NAN standard or protocol.

Each of the devices 104, 108, 110, and 112 may synchronize an internal clock (or perform other synchronization operations) based on information included in the frame 160, such as the TSF value 162. Additionally, in a particular implementation, the first device 104 may use the TSF value 162 to determine packet numbers. The packet number generator 120 may determine a packet number 123 based on the TSF value 162 and may set a value of the packet number counter 122 based on the TSF value 162. The packet number counter 122 may indicate the packet number 123, and the packet number 123 may be used to generate a nonce used in data encryption. In a particular implementation, the packet number generator 120 may perform a modulo (%) operation on the TSF value 162 by 2⁴⁸ to generate a result, and the packet number generator 120 may set an initial value of the packet number counter 122 based on the result.

In another particular implementation, the first device 104 may join the data link group and receive the frame 160 and the first group key 180 from the second device 106. The first device 104 may use one or more packet number initialization values stored at the non-volatile memory 190 to determine packet numbers. For example, the first device 104 may determine that the data link group association data 191 stored at the non-volatile memory 190 corresponds to the first group key 180, and the packet number generator 120 may set a packet number 123 (e.g., a value of the packet number counter 122) to a particular value based on the packet number initialization value 192 in response to the determination that the data link group association data 191 corresponds to the first group key 180. Alternatively, if the first device 104 has not previously joined the data link group during the lifetime of the first group key 180, the first device 104 may generate and store the data link group association data 191 at the non-volatile memory 190, and the packet number initialization value 192 may be included in or indicated by the frame 160 or a message that includes the first group key 180, as non-limiting examples. A value of the packet number counter 122 may be set to the packet number 123, and the packet number 123 may be used to generate a nonce used in data encryption. After setting the packet number 123 based on the packet number initialization value 192, the first device 104 may update the packet number initialization value 192 (e.g., the first device 104 may increment the packet number initialization value 192 by the particular increment value N).

In a particular implementation, the first device 104 may determine the packet number 123 as part of an initialization operation after powering on. In this implementation, the first device 104 may detect a power-on event and the first device 104 may monitor a wireless network associated with the data link group (e.g., the data link group channel) after detecting the power-on event. While the first device 104 is monitoring the wireless network, the first device 104 may receive the frame 160. The first device 104 may join the wireless network 102 and the data link group after receiving the frame 160. For example, the frame 160 may include information indicating devices in the data link group (or the wireless network 102), time periods specified for communication in the data link group (or the wireless network 102), other information related to the data link group or the wireless network 102, or a combination thereof, and the first device 104 may use the information included in the frame 160 and the first group key 180 to join the wireless network 102, the data link group, or both. Alternatively, the first device 104 may periodically set (or update) a value of the packet number counter 122 during operation. The periodic setting (or updating) of the packet number counter 122 may be based on the TSF value 162 or based on the packet number initialization value 192.

After the packet number 123 is determined (e.g., the value of the packet number counter 122 is set), the encryption engine 127 may encrypt data to be included in a packet 170 based on the packet number 123 and a first group key 180. For example, the encryption engine 127 may generate encrypted data 172 based on a nonce that is generated based on the packet number 123 and a MAC address of the first device 104, as further described with reference to FIG. 2. The first group key 180 may be received from the second device 106 during (or after) a process of joining the wireless network 102. Alternatively, the first group key 180 may be received from the second device 106 at another time. The encryption engine 127 may generate the encrypted data 172 based on the nonce and based on the first group key 180. The packet generator 124 may generate the packet 170 based on the encrypted data 172. The first device 104 may transmit the packet 170 to at least one device (e.g., the second device 106) of the data link group. The packet 170 may include the encrypted data 172 that is based on the packet number 123.

Additionally, after generating (or transmitting) the packet 170, the first device 104 may increment the packet number counter 122. For example, a packet number incrementer may increment the packet number counter 122 after the packet 170 is generated (or transmitted), as further described with reference to FIG. 2. After being incremented, the packet number counter 122 may indicate an incremented packet number 125. In a particular implementation, the packet number incrementer (or the packet number counter 122) may be configured to limit the rate of increment of the packet number counter 122 such that the rate of increment of the packet number counter 122 does not exceed a rate of increment of the TSF value 162. As a non-limiting example, the packet number counter 122 stores a 48-bit value, and the packet number counter 122 is incremented at a rate that does not exceed once per μs. In other implementations, the packet number counter 122 may store other size values (e.g., more than 48 bits or fewer than 48 bits), and the packet number counter 122 may be incremented at a different rate. A size and a rate of increment of the packet number counter 122 may be specified by a wireless communication standard, such as a NAN standard. In another particular implementation, the first device 104 (e.g., the packet incrementer) may compare a difference between the value of the packet number counter 122 and the packet number initialization value 192 to an update threshold. In response to determining that the difference is less than (or equal to) the update threshold, the first device 104 may update the packet number initialization value 192 at the non-volatile memory 190.

The first device 104 may generate additional data to be transmitted to devices of the data link group. The encryption engine 127 may generate encrypted data 176 based on the additional data, the incremented packet number 125, and the first group key 180. The packet generator 124 may generate a second packet 174 for transmission to other devices of the data link group. The second packet 174 may include the encrypted data 176 that is based on the incremented packet number 125. The first device 104 may transmit the second packet 174 to at least one device (e.g., the second device 106) of the data link group. In this manner, different packets may include data that is encrypted based on different packet numbers (e.g., different nonces), which satisfies a security criterion of at least one encryption protocol.

The second device 106 may determine whether an expiration condition associated with the first group key 180 is satisfied based on a subset of bits of the TSF value 162 or based on the packet number initialization value 192 (included in the data link group association data 191 stored at the non-volatile memory 196). In a particular implementation, the key expiration monitor 148 may determine the TSF value 162 and the comparator 152 may compare a value of a subset of bits of the TSF value 162 to the threshold 150 (e.g., the expiration threshold). The expiration condition may be satisfied in response to the value of the subset of bits exceeding the threshold 150. The subset of bits may include the 48 LSBs of the TSF value 162. Additionally or alternatively, detecting the expiration condition may include detecting that a particular group of the subset of bits have a particular value. For example, detecting the expiration condition may include detecting that a first group of bits of the subset have a first value (e.g., a logical one value) and that a second group of bits of the subset have a second value (e.g., a logical zero value). As a particular example, the key expiration monitor 148 may detect the expiration condition in response to detecting that the 10 LSBs of the subset have a logical zero value and that the other 38 bits of the subset have a logical one value. Additionally or alternatively, the expiration condition may be detected based on a particular bit of the subset. For example, the packet number may be a 48-bit value, and the expiration condition may be detected in response to detecting that a 49th LSB of the subset of bits has a particular value.

In another particular implementation, the comparator 152 of the key expiration monitor 148 may compare the packet number initialization value 192 to the threshold 150 (e.g., the expiration threshold). The expiration condition may be satisfied by the value of the packet number initialization value 192 being equal to or exceeding the threshold 150. To illustrate, the threshold 150 may have a first set of bits that have a first value (e.g., a logical one value) and a second set of bits that have a second value (e.g., a logical zero value), and the comparator 152 may determine whether the packet number initialization value 192 equals or exceeds the threshold 150. As a particular, non-limiting example, the 38 MSBs of the threshold 150 may have a logical one value, and the 10 LSBs of the threshold 150 may have a logical zero value. In other examples, the threshold 150 may have other values.

The data link group manager 156 may initiate a group key expiration action in response to the expiration condition being satisfied. For example, the data link group manager 156 may cause the key generator 154 to initiate generation of the second group key 182, and the second group key 182 may be distributed to other devices (e.g., the first device 104, the third device 108, and the fifth device 112) of the data link group. As another example, the data link group manager 156 may initiate generation of the second group key 182 at a different device of the data link group. Prior to generation of the second group key 182, the second device 106 may encrypt data based on the first group key 180 and transmit encrypted data to other devices of the data link group. After generating (or receiving) the second group key 182, the second device 106 may encrypt data based on the second group key 182 and may transmit the encrypted data to other devices of the data link group. As another example, the data link group manager 156 may initiate a tear down operation for the data link group in response to the expiration condition being satisfied. For example, the second device 106 may transmit a termination message 184 to other devices (e.g., the first device 104, the third device 108, and the fifth device 112) of the data link group. As another example, the second device 106 may mark the first group key 180 as invalid in a memory of the second device 106.

Devices of the data link group may join other data link groups in addition to the data link group of the wireless network 102. For example, the third device 108 may be part of a second data link group, and the second device 106 may join the second data link group via communications with the third device 108. During a process of joining the second data link group, the second device 106 may receive a third group key 183 from the third device 108. In response to determining that no data link group association data stored at the non-volatile memory 196 is associated with the third group key 183 (e.g., that the data link group association data 191 is not associated with the third group key 183), the second device 106 may generate second data link group association data 197 that is associated with the third group key 183 (and the second data link group). After generating the second data link group association data 197, the second device 106 may store the second data link group association data 197 at the non-volatile memory 196 for use if the second device 106 leaves and rejoins the second data link group at a later time during the lifetime of the third group key 183.

The system 100 prevents re-use of packet numbers, and therefore prevents re-use of nonces used to encrypt data with a particular group key. To illustrate, after a power-up event, the devices 104-112 of the data link group of the wireless network 102 set a value of a packet number counter to a particular value based on the TSF value 162 or based on the packet number initialization value 192. Because devices 104-112 are configured to set a value of a packet number counter to a particular value based on the TSF value 162 or based on the packet number initialization value 192 instead of based on a pre-programmed initialization value, packet numbers may not be repeated (e.g., re-used). For example, the TSF value 162 may be incremented and may not repeat during a validity time period of a particular group key. As another example, the packet number initialization value 192 may be stored at a non-volatile memory of a device and may not repeat during a validity time period of the particular group key. Thus, nonces generated based on the packet numbers may not be repeated (e.g., re-used) while the particular group key is valid. Preventing nonce re-use with a particular group key may enable devices of the data link group to meet security criteria of at least one encryption protocol, such as CCMP encryption. Additionally, the system 100 may prevent a situation where a packet number is repeated. For example, the devices 104-112 may be configured to determine whether an expiration condition of a particular group key is satisfied (based on a subset of bits of the TSF value 162 or based on the packet number initialization value 192). If the expiration condition is satisfied, the devices 104-112 may prevent re-use of nonces (e.g., re-use of packet numbers) with a particular group key by initiating a group key expiration action, such as generation of a new group key or performance of a tear down of the wireless network 102.

In the above description, various functions performed by the system 100 of FIG. 1 are described as being performed by certain components. This division of components is for illustration only. In an alternate implementation, a function performed by a particular component may instead be divided amongst multiple components. Moreover, in an alternate implementation, two or more components of FIG. 1 may be integrated into a single component. Each component illustrated in FIG. 1 may be implemented using hardware (e.g., a field-programmable gate array (FPGA) device, an application-specific integrated circuit (ASIC), a DSP, a controller, etc.), software (e.g., instructions executable by a processor), or a combination thereof.

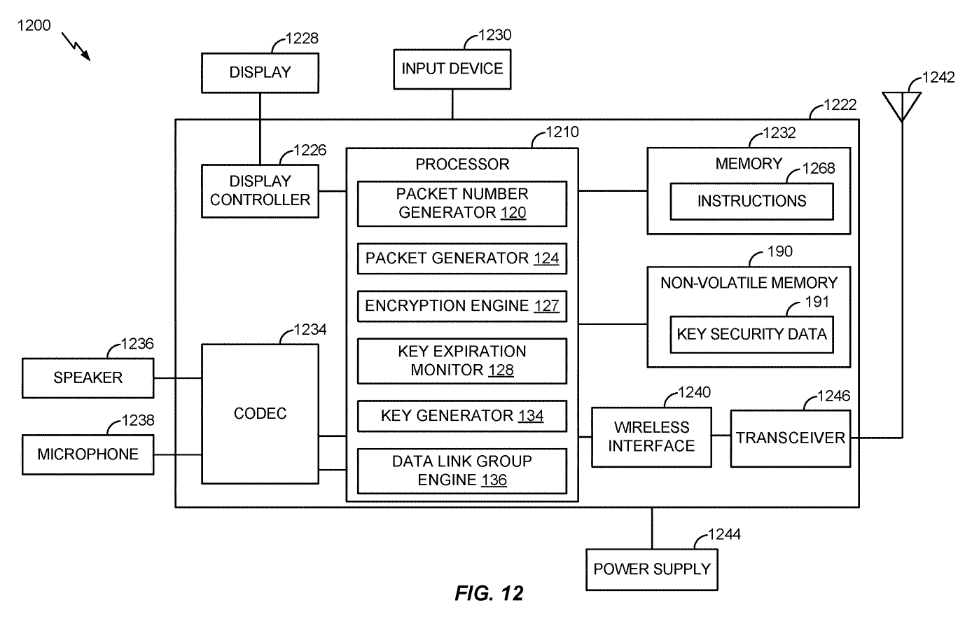

As an illustrative example, a wireless communication device (e.g., one of the devices 104, 106, 108, 110, or 112) may include a memory and a processor coupled to the memory, as described with reference to FIG. 12. The processor may be configured to set a packet number to a particular value in accordance with a packet number initialization scheme associated with a data link group of a NAN and to generate a packet based on the packet number. For example, the processor may be configured to set the packet number 123 to a particular value, and the processor may be configured to generate the packet 170 based on the packet number 123. In a particular implementation, the processor is configured to generate a nonce based on the packet number and a MAC address, and the processor is further configured to encrypt data based on the nonce and a temporal key to generate encrypted data that is included in the packet. For example, the processor may be configured to generate a nonce based on the packet number 123 and a MAC address of the wireless communication device, as described with reference to FIG. 2. The processor may be configured to encrypt data based on the nonce to generate the encrypted data 172. The processor may be further configured to perform CCMP encryption to generate the encrypted data 172, as further described with reference to FIG. 2.

As another illustrative example, a wireless communication device (e.g., one of the devices 104, 106, 108, 110, or 112) may include a memory and a processor coupled to the memory, as described with reference to FIG. 12. The processor may be configured to determine whether an expiration condition associated with a NAN is satisfied based on a subset of bits of a TSF value of the data link group or based on a packet number initialization value stored at a non-volatile memory. For example, the processor may be configured to determine whether an expiration condition is satisfied based on a subset of bits of the TSF value 162 or based on the packet number initialization value 192. The processor may be further configured to initiate a group key expiration action in response to the expiration. For example, the processor may be configured to generate and transmit the second group key 182 or the termination message 184 to other devices. In a particular implementation, the group key expiration action includes initiating generation of a second group key, and the processor is further configured to generate the second group key (e.g., the second group key 182).

Referring to FIG. 2, a block diagram of components of a device of a data link group that is configured to prevent nonce re-use with a particular group key is shown and generally designated 200. In a particular implementation, the device 200 may include or correspond to the devices 104-112 of FIG. 1.

The device 200 includes a depacketizer 202, an authentication data generator 204, a nonce generator 206, the packet number generator 120, a packet number incrementer 208, an encryption header generator 210, the encryption engine 127, and the packet generator 124. As compared to other wireless devices that operate in accordance with an 802.11 standard, the device 200 includes the packet number generator 120 that is configured to set a packet number to a particular value based on the TSF value 162 or based on a packet number initialization value stored at a non-volatile memory (e.g., the packet number initialization value 192 in FIG. 1). In a particular implementation, the packet number generator 120 may be configured to set a value of the packet number counter 122 of FIG. 1 to a particular value based on the TSF value 162. For example, the packet number generator 120 may be configured to perform a modulo (%) operation on the TSF value 162 by 2⁴⁸ to generate a result, and the packet number generator 120 may set an initial value of the packet number counter 122 to a particular value that is equal to the result. In another particular implementation, the packet number generator 120 may be configured to set a value of the packet number counter 122 of FIG. 1 to a particular value based on the packet number initialization value 192. For example, the packet number generator 120 may be configured to set the packet number counter 122 to a particular value based on the packet number initialization value 192 in response to determining that data link group association data (e.g., the data link group association data 191 of FIG. 1) is associated with a received group key (e.g., a temporal key).

The packet number generator 120 may be coupled to the packet number incrementer 208. The packet number generator 120 may provide the packet number 123 to the packet number incrementer 208. The packet number incrementer 208 may be coupled to the nonce generator 206 and to the encryption header generator 210. The packet number incrementer 208 may be configured to increment a packet number counter after generation of a packet. For example, the packet number incrementer 208 may increment the packet number counter 122 of FIG. 1 after generation (or transmission) of a packet that is encrypted based on the packet number 123.

The depacketizer 202 may be coupled to the authentication data generator 204, the nonce generator 206, and the packet generator 124. The depacketizer 202 may be configured to depacketize data and to provide various portions of a data packet, such as MAC headers, MAC addresses, and data, to the authentication data generator 204, the nonce generator 206, and to the packet generator 124. The nonce generator 206 may be coupled to the depacketizer 202 and the encryption engine 127. The nonce generator 206 may be configured to a generate nonce based on the packet numbers and the MAC address (e.g., a transmitter address). The authentication data generator 204 may be coupled to the depacketizer 202 and the encryption engine 127. The authentication data generator 204 may be configured to generate authentication data that, in addition to nonces generated by the nonce generator 206, is used by the encryption engine 127 to encrypt data.

The encryption engine 127 may be coupled to the authentication data generator 204, the nonce generator 206, and the packet generator 124. The encryption engine 127 may be configured to encrypt data based on nonces and group keys. In some implementations, the encryption engine 127 is configured to encrypt data based further on additional authentication data generated by the authentication data generator 204. In a particular implementation, the encryption engine 127 is configured to perform CCMP encryption. In other implementations, the encryption engine 127 is configured to perform encryption in using other encryption protocols. The encryption header generator 210 may be coupled to the packet number incrementer 208 and the packet generator 124. The encryption header generator 210 may be configured to generate encryption headers based on packet numbers and key identifiers (IDs). The key identifier may be a value that indicates a key type of a group key. Key types may include unicast keys, multicast keys, broadcast keys, or other types. The packet generator 124 may be coupled to the depacketizer 202, the encryption engine 127, and the encryption header generator 210. The packet generator may be configured to generate packets (e.g., data packets) based on encryption headers, MAC headers, and encrypted data. For example, the packet generator 124 may be configured to include an encryption header and a MAC header (or portions thereof) in a header of the packet, and the packet generator 124 may be configured to include encrypted data in a payload of the packet.

During operation, the depacketizer 202 receives a data unit 220 and extracts a MAC header 222, a MAC address 224, and data 226 from the data unit 220. In a particular implementation, the data unit 220 includes a MAC protocol data unit (MPDU). The MAC address 224 may be the MAC address associated with the device 200 (e.g., a transmitter address because the device 200 is generating data for transmission to other devices of the data link group). The depacketizer 202 provides the MAC header 222 to the authentication data generator 204 and the packet generator 124. The depacketizer 202 provides the MAC address 224 to the nonce generator 206, and the depacketizer 202 provides the data 226 to the encryption engine 127.

The packet number generator 120 sets the packet number 123 to a particular value based on the TSF value 162 or based on the packet number initialization value 192. In a particular implementation, the packet number generator 120 sets a value of the packet number counter 122 of FIG. 1 to a particular value based on the TSF value 162 after a power-on event at the device 200. Alternatively, the packet number generator 120 may set a value of the packet number counter 122 based on the TSF value 162 periodically during operation of the device 200. In another particular implementation, the packet number generator 120 sets a value of the packet number counter 122 of FIG. 1 to a particular value based on the packet number initialization value 192, either after joining a data link group or periodically (or continually). The packet number generator 120 may determine the packet number 123 indicated by the packet number counter 122 and may provide the packet number 123 to the packet number incrementer 208. The packet number incrementer 208 may increment the packet number 123 (by incrementing the packet number counter 122) after generation (or transmission) of a packet. If a packet has not been generated since generation of the packet number 123, the packet number incrementer 208 may maintain the value of the packet number 123. The packet number incrementer 208 may provide the packet number 123 to the nonce generator 206 and the encryption header generator 210. The encryption header generator 210 may receive the packet number 123 and may generate an encryption header 236 based on the packet number 123 and a key ID 234. In a particular implementation, the encryption header generator 210 may generate a CCMP header and provide the CCMP header to the packet generator

The nonce generator 206 may receive the packet number 123 from the packet number incrementer 208 and may receive the MAC address 224 from the depacketizer 202. The nonce generator may generate a nonce based on the MAC address 224 and the packet number 123. The nonce 230 may be generated using one or more cryptographic techniques. The nonce generator 206 may provide the nonce 230 to the encryption engine 127. The authentication data generator may receive the MAC header 222 from the depacketizer 202, and the authentication data generator 204 may generate additional authentication data 228 based on the MAC header 222. The additional authentication data 228 may be generated in accordance with an encryption protocol used by the encryption engine 127. The authentication data generator 204 may provide the additional authentication data 228 to the encryption engine 127.

The encryption engine 127 may encrypt the data 226 based on a group key 232, the nonce 230, and the additional authentication data 228 to generate the encrypted data 172. The group key 232 may also be referred to as a temporal key. The group key 232 may include the first group key 180 or the second group key 182 of FIG. 1. The group key 232 may be distributed to devices in the data link group to enable encryption and decryption of data. In a particular implementation, the encryption engine 127 is configured to perform CCMP encryption to generate the encrypted data 172. In other implementations, the encryption engine 127 may encrypt the data 226 in accordance with other encryption protocols. The encryption engine 127 may provide the encrypted data to the packet generator 124. The packet generator 124 may generate a packet (e.g., a data packet) based on the encrypted data 172, the encryption header 236, and the MAC header 222. For example, the packet generator 124 may generate a packet having a header that includes information based on the MAC header 222 and the encryption header 236. The packet may have a payload that includes the encrypted data 172. The packet may correspond to the packet 170 or the second packet 174 of FIG. 1. After generation of the packet, the packet may be provided to the wireless interface 126 for transmission to devices of the data link group.

The device 200 prevents re-use of packet numbers, and therefore prevents re-use of nonces with a particular group key. The packet number generator 120 sets a packet number (e.g., an initial packet number) to a particular value based on the TSF value 162 or based on the packet number initialization value 192 (e.g., in accordance with a packet number initialization scheme of a data link group). Because the value of the packet number 123 is based on the TSF value 162 or based on the packet number initialization value 192 instead of based on a pre-programmed initialization value, packet numbers may not be repeated (e.g., re-used) with a particular group key. Thus, nonces generated by the nonce generator 206 based on the packet number 123 may not be repeated (e.g., re-used) while a particular group key is valid. Preventing nonce re-use with a particular group key may meet a security criterion of at least one encryption protocol used by the encryption engine 127.

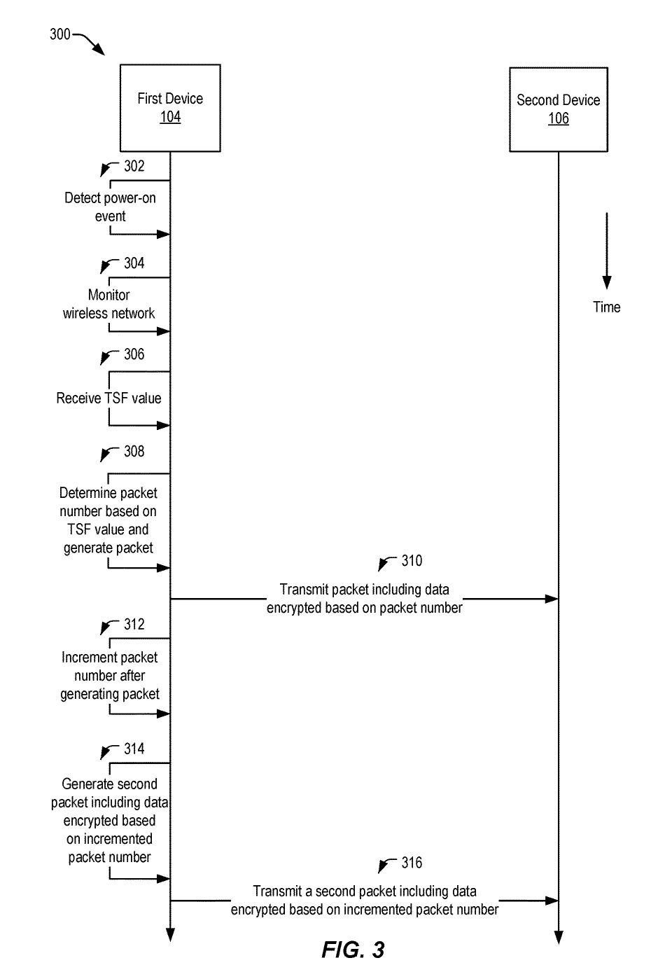

Referring to FIG. 3, a ladder diagram of an illustrative aspect of a method 300 of preventing nonce re-use with a particular group key is shown. The method 300 may be performed wireless devices of a data link group of a NAN. In a particular implementation, the method 300 is performed by the first device 104 and the second device 106 of FIG. 1.

To begin, the first device 104 may be in a powered down state. The powered down state may include being turned off or being in a low-power or powered down mode. At a particular time, the first device 104 may be powered on. The first device 104 may detect a power-on event, at 302. After detecting the power-on event, the first device 104 may monitor a wireless network, at 304. For example, the first device 104 may monitor the NAN channel or the data link group channel for one or more messages.

The first device 104 may receive the TSF value 162, at 306. The first device 104 may receive the TSF value 162 during a synchronization process with respect to the data link group. In some implementations, the first device 104 receives the frame 160 that indicates the TSF value 162 from the second device 106. The frame 160 may be a beacon message or a synchronization message, as two non-limiting examples. In other implementations, the first device 104 receives the TSF value 162 from a different device of the data link group. The first device 104 may set the packet number 123 to a particular value based on the TSF value 162, and the first device 104 may generate the packet 170, at 308. The first device 104 may set a value of the packet number counter 122 based on the TSF value 162, and the packet number counter 122 may indicate the packet number 123. The first device 104 may generate a nonce based on the packet number 123. The first device 104 may encrypt data based on the nonce and a group key, and the encrypted data may be included in the packet. The first device 104 may receive the group key from another device of the data link group prior to generating the packet. For example, the first device 104 may receive the group key as part of an association process with a device of the data link group (e.g., the second device 106 or another device of the data link group). In a particular implementation, the association process may be performed after receipt of the frame 160, which may indicate a nearby device of the data link group (e.g., via a transmitter address in the frame 160). The first device 104 may transmit the packet to the second device 106 (or one or more other devices of the data link group), at 310.

The first device 104 may increment the packet number 123 (e.g., the packet number counter 122) after generating the packet, at 312. The first device 104 may generate a second packet that includes data that is encrypted based on the incremented packet number 125, at 314. The first device 104 may transmit the second packet (including the encrypted data based on the incremented packet number 125) to the second device 106 (or to other devices of the data link group), at 316. Because the packet number 123 is set to a particular value based on the TSF value 162, different data packets may be encrypted using different nonces (based on different packet numbers) while the group key is valid, which satisfies a security criterion of at least one encryption protocol.

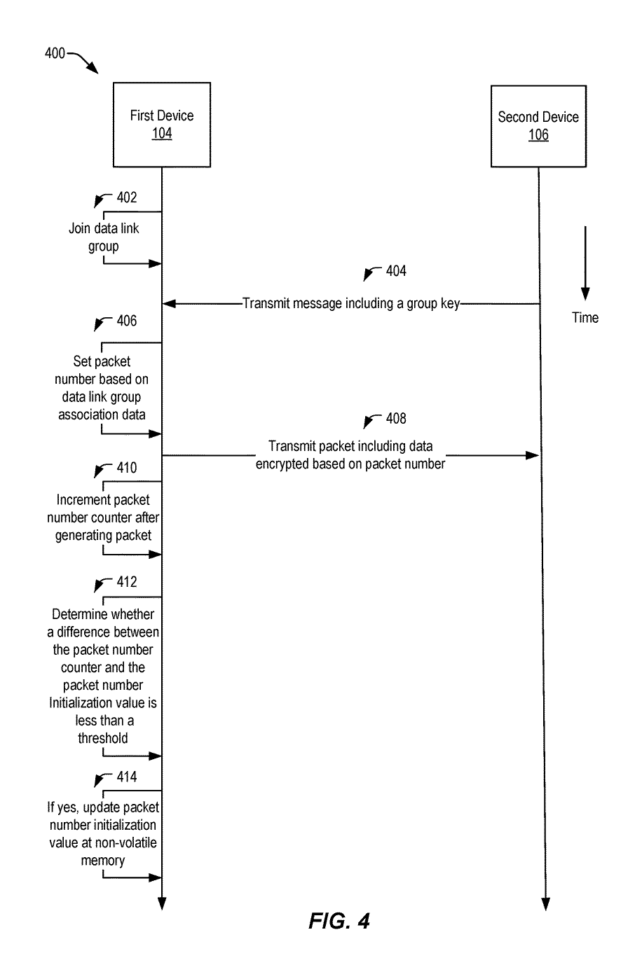

Referring to FIG. 4, a ladder diagram of an illustrative aspect of a method 400 of preventing nonce re-use with a particular group key is shown. The method 400 may be performed wireless devices of a data link group of a NAN. In a particular implementation, the method 400 is performed by the first device 104 and the second device 106 of FIG. 1.

To begin, the first device 104 may be not be part of a data link group. For example, the first device 104 may have disassociated from the data link group (e.g., due to leaving a coverage area, due to a power down operation, or due to some other reason) or the device may not have previously joined the data link group. The first device 104 may join the data link group, at 402. For example, the first device 104 may associate with the second device 106 (which may be a member of the data link group at the particular time). The second device 106 may transmit a message including a group key, at 404. For example, the second device 106 may transmit a message (e.g., a frame) that includes the first group key 180 of FIG. 1. The message may be transmitted as a part of the process of the first device 104 joining the data link group.

The first device 104 may set a packet number to a particular value based on data link group association data, at 406. For example, if the first device 104 has previously joined the data link group during a lifetime of the group key, the first device 104 has stored data link group association data (e.g., the data link group association data 191 of FIG. 1) associated with the group key at a non-volatile memory (e.g., the non-volatile memory 190 of FIG. 1). The first device 104 may set the packet number to a particular value based on a packet number initialization value (e.g., the packet number initialization value 192 of FIG. 1) included in the data link group association data in response to determining that the data link group association data is associated with the group key. Alternatively, if the first device 104 has not previously joined the data link group during the lifetime of the group key, the first device 104 does not currently store, at the non-volatile memory, data link group association data associated with the group key. In this case, the first device 104 generates k data link group association data based on the group key. The message that includes the group key may also include an initial value of the packet number initialization value that corresponds to the data link group, and the generated data link group association data may include the packet number initialization value. Additionally, the first device may set the packet number to a particular value based on the packet number initialization value.

The first device 104 may transmit a packet including data encrypted based on the packet number, at 408. For example, an encryption engine (e.g., the encryption engine 127) of the first device 104 may encrypt data based on a nonce that is generated based on the packet number, as described with reference to FIGS. 1 and 2. A packet generator (e.g., the packet generator 124 of FIG. 1) may generate a packet based on the encrypted data, and the packet may be transmitted to the second device 106.

The first device 104 may increment a packet number counter after generating the packet, at 410. For example, the packet number counter (e.g., the packet number counter 122 of FIG. 1) may indicate the packet number, and the first device 104 may increment the packet number counter after generating the packet. The packet number counter may be incremented so that a packet number is not re-used for data encryption (e.g., to prevent nonce re-use, where the nonce is generated based on the packet number).

The first device 104 may determine whether a difference between a packet number initialization value stored at a non-volatile memory and a value of the packet number counter is less than or equal to an update threshold, at 412. For example, the first device 104 may compare (using a comparator) a difference between the packet number initialization value and the value of the packet number counter to the update threshold. If the difference is less than (or equal to) the update threshold, the first device 104 may update the packet number initialization value at the non-volatile memory, at 414. For example, in response to determining that the difference is less than (or equal to) the update threshold, the first device 104 may update the packet number initialization value. In some implementations, updating the packet number initialization value includes incrementing the packet number initialization value by a particular increment value (N). Because the packet number is set to a particular value based on the packet number initialization value, different data packets may be encrypted using different nonces (based on different packet numbers) while the group key is valid, which satisfies a security requirement of at least one encryption protocol.

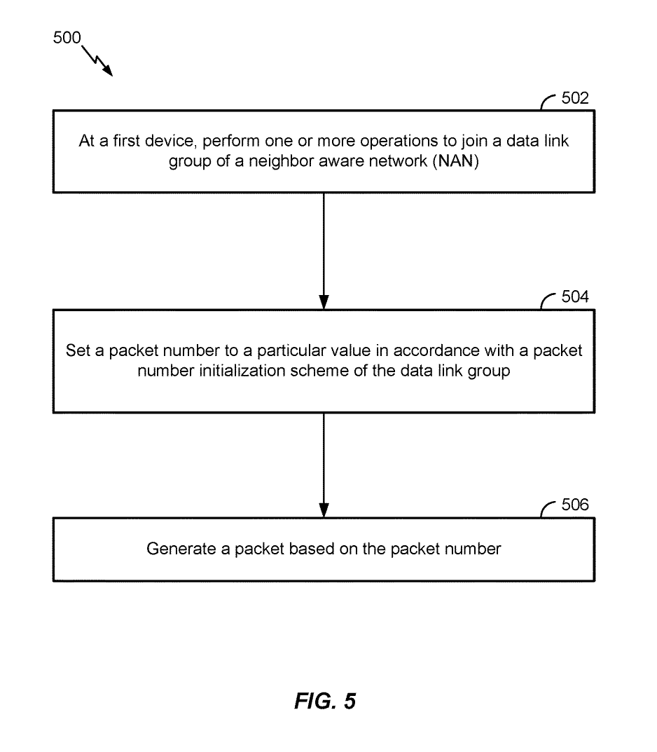

Referring to FIG. 5, a method 500 of operation at a device of a data link group is shown. The method 500 may include a method of wireless communication. In a particular implementation, the method 500 may be performed at any of the devices 104-112 of FIG. 1 (e.g., the method 500 may correspond to a multi-hop data link), the device 200 of FIG. 2, or the devices 104 and 106 of FIGS. 3 and 4.

The method 500 includes, at a first device, performing one or more operations to join a data link group of a neighbor aware network (NAN), at 502. For example, the first device 104 may join a data link group of the wireless network 102 (e.g., the NAN) by performing an association operation with a device that is included in the wireless network 102. The data link group may include multiple devices configured to perform wireless communications during a designated time, such as a paging window. For example, the second device 106 may be included in the data link group of the wireless network 102.

The method 500 includes setting a packet number to a particular value in accordance with a packet number initialization scheme of the data link group, at 504. For example, the packet number generator 120 may set the packet number 123 to a particular value in accordance with a packet number initialization scheme associated with the data link group of the wireless network 102.

The method 500 includes generating a packet based on the packet number, at 506. For example, the packet generator 124 may generate the packet 170 based on the packet number 123. In a particular implementation, the method 500 includes transmitting the packet to a second device of the data link group. The packet includes data that is encrypted using a nonce that is generated based on the packet number. To illustrate, the packet 170 may include the encrypted data 172. The encrypted data 172 may be encrypted based on a nonce that is generated based on the packet number 123.

In a particular implementation, the packet number initialization scheme includes storing one or more packet number initialization values associated with the data link group at a non-volatile memory of the first device. For example, the first device 104 may include the non-volatile memory 190 that is configured to store one or more packet number initialization values. The packet number initialization scheme corresponds to group-addressed traffic. Additionally, the method 500 may further include accessing data link group association data stored at a non-volatile memory of the first device, where the packet number is set to a packet number initialization value stored at the non-volatile memory. For example, the first device 104 may access the data link group association data 191 to set the packet number 123 to a particular value based on the packet number initialization value 192.

The data link group association data may indicate a packet number initialization value, and the packet number may be set to the particular value based on the packet number initialization value. For example, the data link group association data 191 may include (or indicate) the packet number initialization value 192, and the packet number may be set to a particular value based on the packet number initialization value 192. The particular value may be equal to the packet number initialization value plus one. Additionally or alternatively, the data link group association data may be associated with the data link group, and the data link group association data may further indicate a group key identifier, a data link group identifier, a group key, a lifetime of the group key, or a combination thereof. For example, the data link group association data 191 may include (or indicate) the group key ID 193, the data link group ID 194, the first group key 180, the lifetime indicator 195, or a combination thereof.

In the implementation where the packet number initialization scheme includes storing one or more packet number initialization values at a non-volatile memory of the first device, the method 500 may further include receiving a group key from a second device of the data link group in response to joining the data link group and determining whether stored data link group association data corresponds to the group key. For example, the first device 104 may receive the first group key 180 from the second device 106 in response to joining the data link group, and the first device 104 may determine whether stored data link group association data at the non-volatile memory 190 corresponds to the first group key 180. The data link group association data may be accessed based on a determination that the data link group association data corresponds to the group key. For example, the data link group association data 191 may be accessed by the first device 104 based on a determination that the data link group association data 191 corresponds to the first group key 180.

Additionally or alternatively, the method 500 may include in response to determining that the stored data link group association data does not correspond to a second group key associated with a second data link group, setting a second packet number to an initial value in response to joining the second data link group. For example, the second device 106 may join a second data link group and receive the third group key 183 from the third device 108. The second device 106 may determine whether stored data link group association data at the non-volatile memory 196 corresponds to the third group key 183 and, in response to determining that the stored data link group association data does not correspond to the third group key 183, the second device 106 may set a second packet number to an initial value (indicated by a message that includes the third group key 183). The method 500 may also include storing second data link group association data at a non-volatile memory of the device, the second data link group association data corresponding to the second group key. For example, the second device 106 may generate and store second data link group association data 197 at the non-volatile memory 196. The second data link group association data 197 may correspond to the third group key 183.

In the implementation where the packet number initialization scheme includes storing one or more packet number initialization values at a non-volatile memory of the first device, the method 500 may include incrementing a packet number counter after generating the packet. For example, a packet number incrementer (e.g., the packet number incrementer 208 of FIG. 2) of the first device 104 may increment the packet number counter 122 after generating the packet 170. The method 500 may further include determining whether a difference between a value of the packet number counter and the packet number initialization value is less than or equal to an update threshold and, in response to determining that the difference is less than or equal to the update threshold, updating the packet number initialization value at a non-volatile memory of the first device. For example, the first device 104 may determine whether a difference between a value of the packet number counter 122 and the packet number initialization value 192 is less than or equal to an update threshold. In response to determining that the difference is less than or equal to the update threshold, the first device 104 may update the packet number initialization value 192.

The method 500 may further include receiving a message that indicates the update threshold from a second device of the data link group. For example, the update threshold may be indicated by the frame 160 or a message that includes the first group key 180. Additionally or alternatively, updating the packet number initialization value may include incrementing the packet number initialization value by a particular increment value. For example, the first device 104 may increment the packet number initialization value 192 by the particular increment value N, as described with reference to FIG. 1. The method 500 may further include receiving a message that indicates the particular increment value from a second device of the data link group. For example, the particular increment value N may be included in the frame 160 or a message that includes the first group key 180. In an alternate implementation, the method 500 may further include updating a packet number initialization value stored at a non-volatile memory of the first device in response to incrementing the packet number counter. For example, the first device 104 may update the value of the packet number initialization value 192 in response to incrementing the packet number counter 122.

In another particular implementation, the method 500 includes generating, at the first device, a nonce based on the packet number and a media access control (MAC) address of the first device. For example, the nonce generator 206 may generate the nonce 230 based on the packet number 123 and the MAC address 224. Additionally, the method 500 may include encrypting, at the first device, data based on the nonce and a temporal key to generate encrypted data. For example, the encryption engine 127 may encrypt the data 226 based on the nonce 230 and the group key 232 (e.g., a temporal key) to generate the encrypted data 172. The temporal key may include a group key of the data link group. The data may be encrypted further based on additional authentication data. For example, the encryption engine 127 may encrypt the data 226 based further on the additional authentication data 228. The method 500 may further include authenticating data based on the temporal key. For example, data may be authenticated based on the first group key 180 (e.g., the temporal key). Encrypting the data 226 may include performing counter mode cipher block chaining message authentication code protocol (CCMP) encryption on the data 226 to generate the encrypted data 172. Alternatively, the encrypted data 172 may be generated in accordance with other encryption protocols.

Additionally, the method 500 may include generating, at the first device, a CCMP header based on the packet number and a key identifier. For example, the encryption header generator 210 may generate the encryption header 236 based on the packet number 123 and the key ID 234. The encryption header 236 may be a CCMP header. The key ID 234 may include a value that indicates whether the packet is to be transmitted to a single device of the data link group or to multiple devices of the data link group. In a particular implementation, the key ID 234 may include a two-bit value. The packet may be generated based on the CCMP header (e.g., the encryption header 236), a MAC header of the data (e.g., the MAC header 222), and the encrypted data 172.

In another particular implementation, the method 500 includes transmitting the packet from the first device to at least one device of the data link group. For example, the first device 104 may transmit the packet 170 to the second device 106.

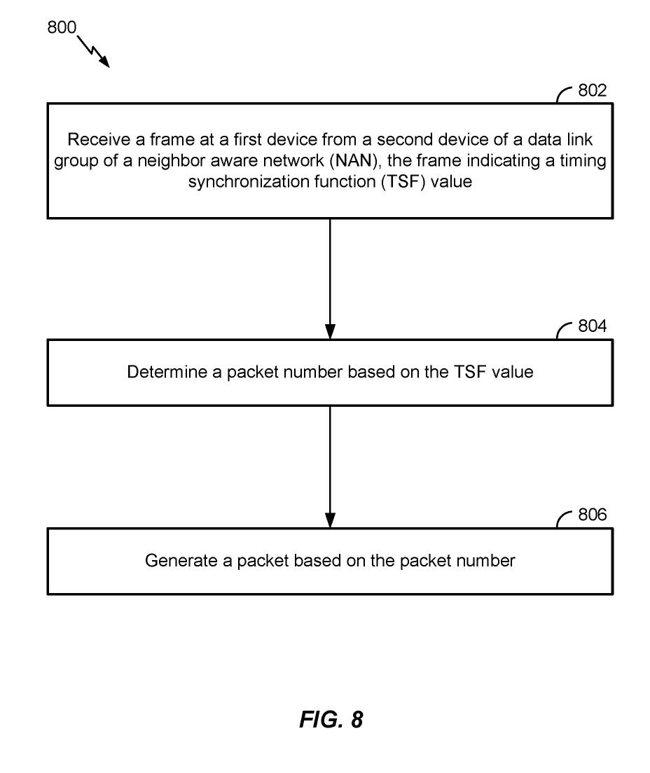

In another particular implementation, the packet number initialization scheme may include setting one or more packet numbers based on one or more timing synchronization function (TSF) values. In this implementation, the method 500 may further include receiving a frame at the first device from a second device of the data link group, the frame indicating a TSF value, where the packet number is set based on the TSF value. For example, the first device 104 may receive the frame 160 from the second device 106. The frame may indicate the TSF value 162, and the packet number 123 may be set to a particular value based on the TSF value 162. For example, the particular value may include a set of bits of the TSF value or a result of a modulo operation performed on the TSF value. Additional details regarding setting packet numbers based on the TSF value 162 are further described with reference to FIG. 8.

The method 500 prevents re-use of packet numbers, and therefore prevents re-use of nonces with a particular group key. For example, a packet number may be set based on the TSF value 162 or based on the packet number initialization value 192, instead of being set to an initial value. Because the packet number is set based on the TSF value 162 or the packet number initialization value 192 (instead of based on a pre-programmed initialization value), packet numbers (and nonces) may not be repeated (e.g., re-used) while a particular group key is valid. Preventing nonce re-use with a particular group key satisfies a security criterion of at least one encryption protocol.

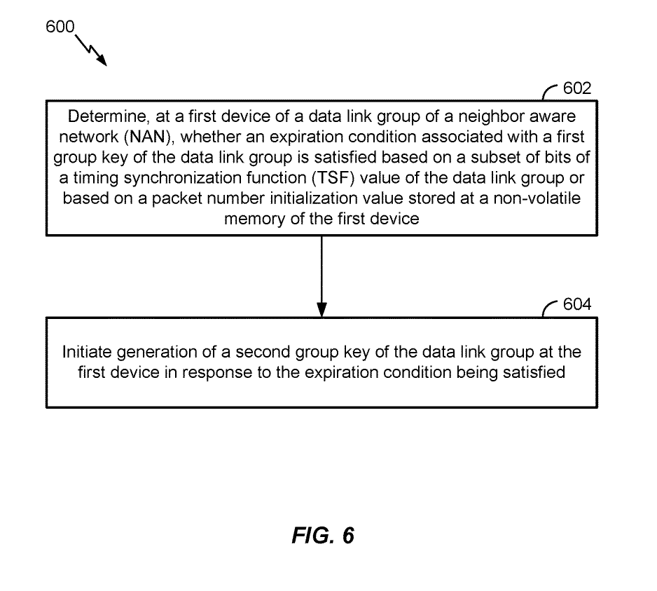

Referring to FIG. 6, a method 600 of operation at a device of a data link group is shown. The method 600 may include a method of wireless communication. In a particular implementation, the method 600 may be performed at any of the devices 104-112 of FIG. 1 (e.g., the method 500 may correspond to a multi-hop data link), the device 200 of FIG. 2, or the devices 104 and 106 of FIGS. 3 and 4.

The method 600 includes determining, at a first device of a data link group of a neighbor aware network (NAN) whether an expiration condition associated with a first group key of the data link group is satisfied based on a subset of bits of a timing synchronization function (TSF) value of the data link group or based on a packet number initialization value stored at a non-volatile memory of the first device, at 602. For example, the key expiration monitor 148 of the second device 106 (or the key expiration monitor 128 of the first device 104) may determine whether an expiration condition associated with the first group key 180 is satisfied based on a subset of bits of the TSF value 162 or the packet number initialization value 192 (included in the data link group association data 191) stored at the non-volatile memory 196.

The method 600 includes initiating generation of a second group key of the data link group at the first device in response to the expiration condition being satisfied, at 604. For example, the key generator 154 may initiate generation of the second group key 182 in response to the expiration condition being satisfied. The expiration condition may indicate that a lifetime of the data link group exceeds a threshold value.

In a particular implementation, detecting the expiration condition includes comparing a value of the subset of bits of the TSF value to a threshold and determining that the value of the subset of bits of the TSF value exceeds the threshold. For example, the second device 106 may compare a subset of bits of the TSF value 162 to the threshold 150 and determine that the subset of bits of the TSF value 162 exceeds the threshold 150. The subset of bits of the TSF value 162 may include forty-eight least significant bits (LSBs) of the TSF value 162. In another particular implementation, detecting the expiration condition may include detecting that a particular group of the subset of bits have a particular value. For example, the second device 106 may detect the expiration condition in response to detecting that a first group (e.g., the 10 LSBs) of the subset of bits of the TSF value 162 have a logical zero value and that a second group (e.g., the other 38 bits) of the subset of bits of the TSF value 162 have a logical one value. In another particular implementation, detecting the expiration condition may include detecting that a set of bits of the packet number initialization value has a particular value. For example, the second device 106 may compare the packet number initialization value 192 (which is included in the data link group association data 191 stored at the non-volatile memory 196) to a threshold value to detect that the packet number initialization value 192 has a particular value.

In another particular implementation, the method 600 further includes determining the TSF value. For example, the second device 106 may determine the TSF value 162. Determining the TSF value 162 may include generating the TSF value 162 at the second device 106. For example, the second device 106 may generate the TSF value 162 during operation as an anchor master device. Alternatively, determining the TSF value may 162 include receiving a frame from a different device of the data link group, the frame indicating the TSF value 162. For example, the second device 106 may receive a frame that includes the TSF value 162 from a device that is operating as an anchor master device. In another particular implementation, the method 600 includes initializing the TSF value 162 to a particular value concurrently with formation of the data link group. The initial value may be a zero value.

In another particular implementation, the method 600 includes, prior to determining that the expiration condition is satisfied, generating encrypted data based on the first group key and transmitting the encrypted data to at least one device of the data link group. For example, the second device 106 may generate and transmit data that is encrypted based on the first group key 180 prior to detecting the expiration condition. In another particular implementation, the method 600 includes generating a second group key at the device and transmitting the second group key to at least one other device of the data link group. For example, the second device 106 may transmit the second group key 182 to the first device 104, the third device 108, and the fifth device 112. Additionally, the method 600 may include generating encrypted data based on the second group key and transmitting the encrypted data to at least one device of the data link group.

The method 600 may prevent a situation where a packet number is repeated while a particular group key is valid. For example, a device may be configured to determine whether an expiration condition of a particular group key is satisfied. If the expiration condition is satisfied, the device may prevent re-use of nonces (e.g., re-use of packet numbers) with the particular group key by initiating generation of a new group key.

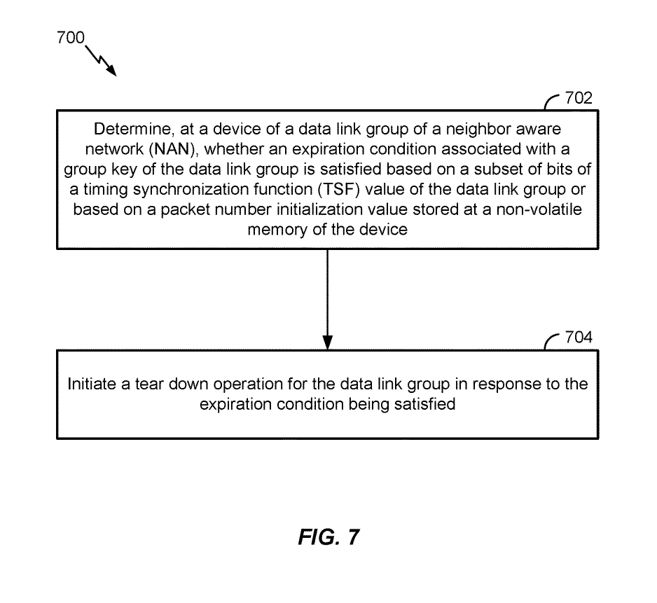

Referring to FIG. 7, a method 700 of operation at a device of a data link group is shown. The method 700 may include a method of wireless communication. In a particular implementation, the method 700 may be performed at any of the devices 104-112 of FIG. 1 (e.g., the method 500 may correspond to a multi-hop data link), the device 200 of FIG. 2, or the devices 104 and 106 of FIGS. 3 and 4.

The method 700 includes determining, at a first device of a data link group of a neighbor aware network (NAN) whether an expiration condition associated with a first group key of the data link group is satisfied based on a subset of bits of a timing synchronization function (TSF) value of the data link group or based on a packet number initialization value stored at a non-volatile memory of the first device, at 602. For example, the key expiration monitor 148 of the second device 106 (or the key expiration monitor 128 of the first device 104) may determine whether an expiration condition associated with the first group key 180 is satisfied based on a subset of bits of the TSF value 162 or the packet number initialization value 192 (included in the data link group association data 191) stored at the non-volatile memory 196.

The method 700 includes initiating a tear down operation for the data link group in response to the expiration condition being satisfied, at 704. For example, the data link group manager 156 may initiate a tear down operation of the data link group in response to the expiration condition being satisfied.

In a particular implementation, detecting the expiration condition includes comparing a value of the subset of bits to a threshold value and determining that the value of the subset of bits exceeds the threshold value. For example, the key expiration monitor 148 may compare a value of the subset of bits of the TSF value 162 to the threshold 150. The expiration condition associated with the first group key 180 is satisfied in response to the value of the subset of bits of the TSF value 162 exceeding the threshold 150. In another particular implementation, detecting the expiration condition includes comparing a value of a set of bits of the packet number initialization value to a threshold value and determining that the value of the set of bits of the packet number initialization value exceeds the threshold value. For example, the key expiration monitor 148 may compare a value of a set of bits of the packet number initialization value 192 (included in the data link group association data 191 stored at the non-volatile memory 196) to the threshold 150. The expiration condition associated with the first group key 180 may be satisfied in response to the value of the set of bits of the packet number initialization value 192 exceeding the threshold 150.

In another particular implementation, the tear down operation includes marking the group key as invalid in a memory of the device. For example, the data link group manager 156 may mark the first group key 180 as invalid in a memory of the second device 106. Additionally or alternatively, the tear down operation includes transmitting the termination message to at least one other device of the data link group. For example, the data link group manager 156 may initiate transmission of the termination message 184 to other devices of the data link group, such as the first device 104, the third device 108, and the fifth device 112.

The method 700 may prevent a situation where a packet number is repeated while a particular group key is valid. For example, a device may be configured to determine whether an expiration condition of a particular group key is satisfied. If the expiration condition is satisfied, the device may prevent re-use of nonces (e.g., re-use of packet numbers) with a particular group key by initiating tear down a data link group (or a NAN).

Referring to FIG. 8, a method 800 of operation at a device of a data link group is shown. The method 800 may include a method of wireless communication. In a particular implementation, the method 800 may be performed at any of the devices 104-112 of FIG. 1 (e.g., the method 800 may correspond to a multi-hop data link), the device 200 of FIG. 2, or the devices 104 and 106 of FIGS. 3 and 4.

The method 800 includes receiving a frame at a first device from a second device of a data link group of a neighbor aware network (NAN), the frame indicating a timing synchronization function (TSF) value, at 802. For example, the first device 104 may receive the frame 160 from the second device 106. The data link group may include multiple devices configured to enter an active state associated with performing wireless communications during one or more designated time periods, such as a paging window. The frame 160 may include the TSF value 162. In a particular implementation, the TSF value 162 indicates a time determined by an anchor master device of the wireless network 102. The second device 106 of the data link group may be operating as an anchor master device of the data link group during receipt of the frame 160 at the first device 104. In a particular implementation, the frame 160 includes a NAN beacon message.

The method 800 includes determining a packet number based on the TSF value, at 804. For example, the packet number generator 120 may determine the packet number 123 based on the TSF value 162. The TSF value 162 may include a sixty-four-bit value. The packet number 123 may include a forty-eight-bit value. In a particular implementation, the method 800 includes setting an initial value of a packet number counter 122 based on the TSF value 162. The packet number counter 122 may indicate the packet number 123. For example, the packet number counter 122 may track a packet number used by the first device 104. In a particular implementation, setting the initial value of the packet number counter 122 may include performing a modulo (%) operation on the TSF value 162 by 2⁴⁸ to generate a result and setting the initial value of the packet number counter 122 based on a value of the result.

The method 800 includes generating a packet based on the packet number, at 806. For example, the packet generator 124 may generate the packet 170 based on the packet number 123. To illustrate, the packet 170 may include the encrypted data 172. The encrypted data 172 may be encrypted based on a nonce that is generated based on the packet number 123.

In another particular implementation, the method 800 includes joining the data link group, receiving a group key from at least one device of the data link group after joining the data link group, and receiving the frame 160 from the second device 106 after joining the data link group. For example, the first device 104 may join the data link group by associating with the second device 106 and receiving the first group key 180 from the second device 106. After joining the data link group, the first device 104 may receive the frame 160 from the second device 106. Additionally or alternatively, the method 800 may include disassociating from the data link group after transmitting the packet to at least one device of the data link group and re-joining the data link group after disassociating from the data link group. The method 800 further includes receiving a group key from at least one device of the data link group after re-joining the data link group and receiving a second frame from the at least one device, the frame indicating an updated TSF value. To illustrate, the first device 104 may disassociate from the data link group after transmitting the packet 170. The first device 104 may re-join the data link group at a later time by performing one or more association operations with the second device 106. During (or after) the one or more association operations, the first device 104 may receive a group key (e.g., an updated group key) and a second frame indicating an updated TSF value.

In another particular implementation, the method 800 includes detecting a power-on event at the first device 104 and monitoring a wireless network associated with the data link group for one or more messages after detecting the power-on event. For example, the first device 104 may detect a power-on event and may monitor a data link group channel or a NAN channel. The frame 160 may be received via the wireless network in response to monitoring the wireless network. Additionally, the method 800 may include joining the data link group after receiving the frame 160. For example, the frame 160 may include information related to the data link group (or the wireless network 102), and the first device 104 may use the information to join the data link group (or the wireless network 102). Joining the data link group may include performing one or more association operations with a device of the data link group (e.g., the second device 106 or another device of the data link group). During the association operations, the first device 104 may receive the first group key 180.

In another particular implementation, the method 800 includes generating, at the first device 104, a nonce based on the packet number 123 and a media access control (MAC) address of the first device 104. For example, the nonce generator 206 may generate the nonce 230 based on the packet number 123 and the MAC address 224. Additionally, the method 800 may include encrypting, at the first device 104, data based on the nonce and a temporal key to generate encrypted data. For example, the encryption engine 127 may encrypt the data 226 based on the nonce 230 and the group key 232 (e.g., a temporal key) to generate the encrypted data 172. The temporal key may include a group key of the data link group. The data may be encrypted further based on additional authentication data. For example, the encryption engine 127 may encrypt the data 226 based further on the additional authentication data 228. Encrypting the data 226 may include performing counter mode cipher block chaining message authentication code protocol (CCMP) encryption on the data 226. Alternatively, the encrypted data 172 may be generated in accordance with other encryption protocols.

Additionally, the method 800 may include generating, at the first device 104, a CCMP header based on the packet number 123 and a key identifier. For example, the encryption header generator 210 may generate the encryption header 236 based on the packet number 123 and the key ID 234. The encryption header 236 may be a CCMP header. The key ID 234 may include a value that indicates whether the packet is to be transmitted to a single device of the data link group or to multiple devices of the data link group. In a particular implementation, the key ID 234 may include a two-bit value. The packet may be generated based on the CCMP header (e.g., the encryption header 236), a MAC header of the data (e.g., the MAC header 222), and the encrypted data 172.

In another particular implementation, the method 800 includes transmitting the packet 170 from the first device 104 to at least one device of the data link group. For example, the first device 104 may transmit the packet 170 to the second device 106. Additionally or alternatively, the method 800 may include incrementing the packet number counter 122 after generating (or transmitting) the packet 170. A rate of increment of the packet number counter 122 may not exceed a rate of increment of the TSF value 162.

The method 800 prevents re-use of packet numbers, and therefore prevents re-use of nonces with a particular group key. For example, a packet number may be determined based on the TSF value 162 instead of set to an initial value. Because the packet number is determined based on the TSF value 162 instead of based on a pre-programmed initialization value, packet numbers (and nonces) may not be repeated (e.g., re-used) while a particular group key is valid. Preventing nonce re-use with a particular group key satisfies a security criterion of at least one encryption protocol.

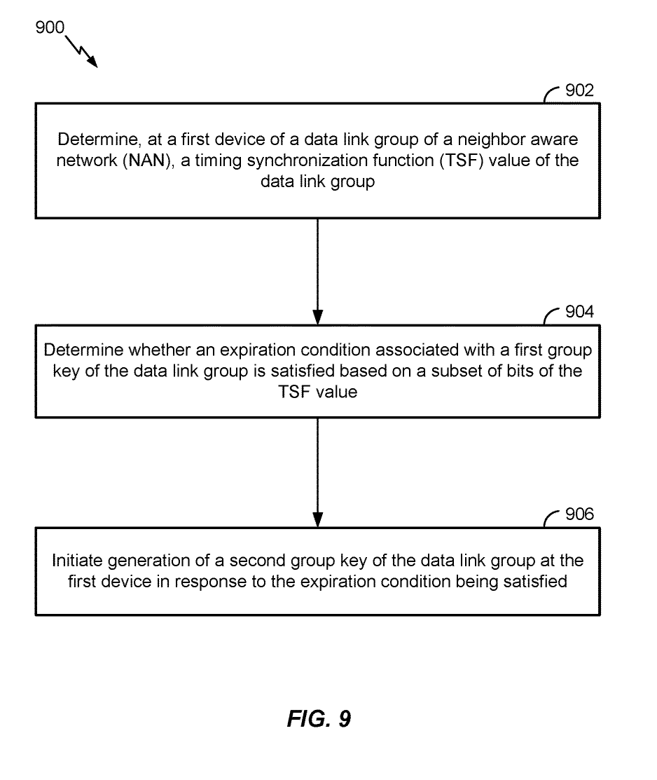

Referring to FIG. 9, a method 900 of operation at a device of a data link group is shown. In a particular implementation, the method 900 may be performed at any of the devices 104-112 of FIG. 1 (e.g., the method 900 may correspond to a multi-hop data link), the device 200 of FIG. 2, or the devices 104 and 106 of FIGS. 3 and 4.

The method 900 includes determining, at a first device of a data link group of a neighbor aware network (NAN), a timing synchronization function (TSF) value of the data link group, at 902. For example, the second device 106 may determine the TSF value 162.

The method 900 includes determining whether an expiration condition associated with a first group key of the data link group is satisfied based on a subset of bits of the TSF value, at 904. For example, the key expiration monitor 148 may determine whether an expiration condition associated with the first group key 180 is satisfied based on a subset of bits of the TSF value 162. The subset of bits may include forty-eight least significant bits (LSBs) of the TSF value 162.

The method 900 includes initiating generation of a second group key of the data link group at the first device in response to the expiration condition being satisfied, at 906. For example, the key generator 154 may initiate generation of the second group key 182 in response to the expiration condition being satisfied. The expiration condition may indicate that a lifetime of the data link group exceeds a threshold value.

In a particular implementation, detecting the expiration condition includes comparing a value of the subset of bits to the threshold 150 and determining that the value of the subset of bits exceeds the threshold 150. Alternatively, detecting the expiration condition may include detecting that a particular group of the subset of bits have a particular value. For example, detecting the expiration condition may include detecting that a particular group of the subset of bits have a logical zero value (e.g., the 10 LSBs of the subset) and a second group of the subset of bits have a logical one value (e.g., the other 38 bits of the subset).

In another particular implementation, determining the TSF value 162 includes generating the TSF value 162 at the second device 106. For example, the second device 106 may generate the TSF value 162 while operating as an anchor master device. Alternatively, determining the TSF value 162 includes receiving a frame from a different device of the data link group, the frame indicating the TSF value 162. For example, the second device 106 may receive a frame that includes the TSF value 162 from a device that is operating as an anchor master device. In another particular implementation, the method 900 includes initializing the TSF value 162 to a particular value concurrently with formation of the data link group. The initial value may be a zero value.

In another particular implementation, the method 900 includes, prior to determining that the expiration condition is satisfied, generating encrypted data based on the first group key 180 and transmitting the encrypted data to at least one device of the data link group. For example, the second device 106 may generate and transmit data that is encrypted based on the first group key 180 prior to detecting the expiration condition. In another particular implementation, the method 900 includes generating the second group key 182 at the second device 106 and transmitting the second group key 182 to at least one other device of the data link group. For example, the second device 106 may transmit the second group key 182 to the first device 104, the third device 108, and the fifth device 112. Additionally, the method 900 may include generating encrypted data based on the second group key 182 and transmitting the encrypted data to at least one device of the data link group.

The method 900 may prevent a situation where a packet number is repeated while a particular group key is valid. For example, a device may be configured to determine whether an expiration condition of a particular group key is satisfied. If the expiration condition is satisfied, the device may prevent re-use of nonces (e.g., re-use of packet numbers) with the particular group key by initiating generation of a new group key.

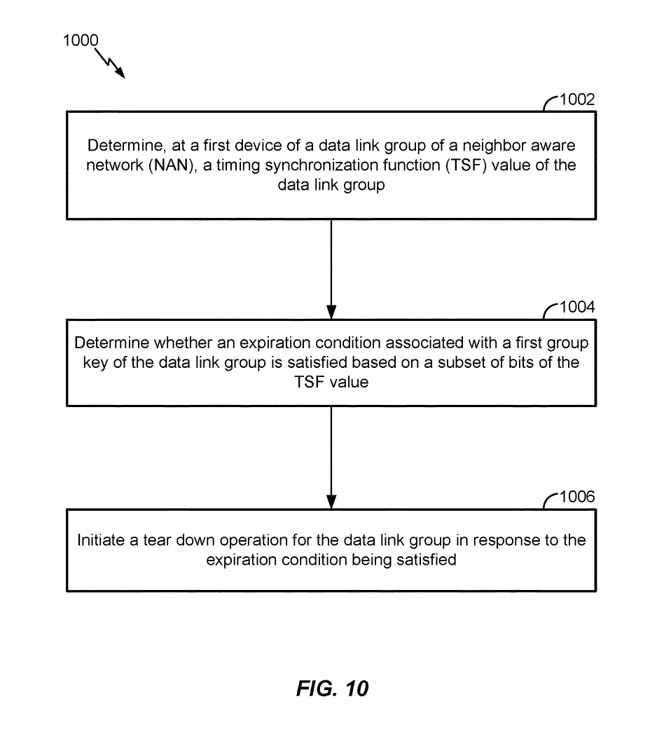

Referring to FIG. 10, a method 1000 of operation at a device of a data link group is shown. In a particular implementation, the method 1000 may be performed at any of the devices 104-112 of FIG. 1 (e.g., the method 1000 may correspond to a multi-hop data link), the device 200 of FIG. 2, or the devices 104 and 106 of FIGS. 3 and 4.

The method 1000 includes determining, at a device of a data link group of a neighbor aware network (NAN), a timing synchronization function (TSF) value of the data link group, at 1002. For example, the second device 106 may determine the TSF value 162.

The method 1000 includes determining whether an expiration condition associated with a group key of the data link group is satisfied based on a subset of bits of the TSF value, at 1004. For example, the key expiration monitor 148 may determine whether an expiration condition associated with the first group key 180 is satisfied based on a subset of bits of the TSF value 162. The subset of bits may include forty-eight least significant bits (LSBs) of the TSF value 162.

The method 1000 includes initiating a tear down operation for the data link group in response to the expiration condition being satisfied, at 1006. For example, the data link group manager 156 may initiate a tear down operation of the data link group in response to the expiration condition being satisfied.

In a particular implementation, the detecting the expiration condition includes comparing a value of the subset of bits to a threshold value and determining that the value of the subset of bits exceeds the threshold value. For example, the key expiration monitor 148 may compare a value of the subset of bits of the TSF value 162 to the threshold 150. The expiration condition associated with the first group key 180 is satisfied if the value of the subset exceeds the threshold 150.

In another particular implementation, the tear down operation includes marking the group key as invalid in a memory of the device. For example, the data link group manager 156 may mark the first group key 180 as invalid in a memory of the second device 106. Additionally or alternatively, the tear down operation includes transmitting a termination message to at least one other device of the data link group. For example, the data link group manager 156 may initiate transmission of the termination message 184 to other devices of the data link group, such as the first device 104, the third device 108, and the fifth device 112.

The method 1000 may prevent a situation where a packet number is repeated while a particular group key is valid. For example, a device may be configured to determine whether an expiration condition of a particular group key is satisfied. If the expiration condition is satisfied, the device may prevent re-use of nonces (e.g., re-use of packet numbers) with a particular group key by initiating tear down a data link group (or a NAN).

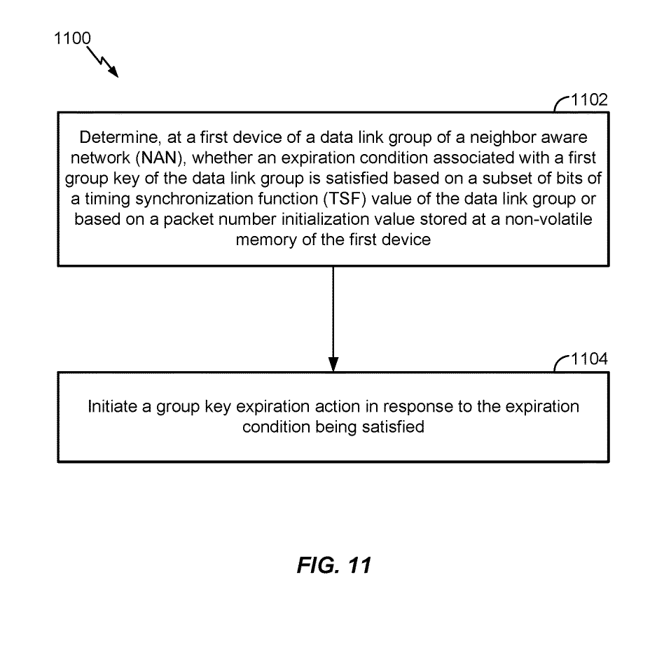

Referring to FIG. 11, a method 1100 of operation at a device of a data link group is shown. In a particular implementation, the method 1100 may be performed at any of the devices 104-112 of FIG. 1 (e.g., the method 1100 may correspond to a multi-hop data link), the device 200 of FIG. 2, or the devices 104 and 106 of FIGS. 3 and 4.

The method 1100 includes determining, at a first device of a data link group of a neighbor aware network (NAN), whether an expiration condition associated with a first group key of the data link group is satisfied based on a subset of bits of a timing synchronization function (TSF) value of the data link group or based on a packet number initialization value stored at a non-volatile memory of the first device, at 1102. For example, first device may include the first device 104 or the second device 106, the first group key may include the first group key 180, the TSF value may include the TSF value 162, the packet number initialization value may include the packet number initialization value 192, and the non-volatile memory may include the non-volatile memory 190 or the non-volatile memory 196 of FIG. 1.

The method 1100 further includes initiating a group key expiration action in response to the expiration condition being satisfied, at 1104. For example, the data link group manager 136 or the data link group manager 156 may initiate the group key expiration action in response to the expiration condition being satisfied. The expiration condition may indicate that a lifetime of the data link group exceeds a threshold value.

In a particular implementation, the group key expiration action includes generating a second group key of the data link group. For example, the data link group manager 156 may cause the key generator 154 to generate the second group key 182. The method 1100 may further include generating a second group key at the first device, transmitting the second group key to a second device of the data link group, generating encrypted data based on the second group key, and transmitting the encrypted data to at least one device of the data link group.

In another particular implementation, the group key expiration action includes initiating a tear down operation for the data link group. For example, the data link group manager 156 may initiate a tear down operation in response to the expiration condition being satisfied. The tear down operation may include marking the group key as invalid in a memory of the first device. For example, the first group key 180 may be marked invalid in response to the expiration condition being satisfied. Additionally or alternatively, the tear down operation may include transmitting a termination message to at least one other device of the data link group. For example, the termination message may include the termination message 184 of FIG. 1.

In another particular implementation, detecting the expiration condition includes comparing a value of the subset of bits of the TSF value to a threshold value and determining that the value of the subset of bits of the TSF value exceeds the threshold value. For example, the TSF value may include the TSF value 162, and the threshold may include the threshold 150 of FIG. 1. Additionally or alternatively, detecting the expiration condition may include comparing a value of a set of bits of the packet number initialization value to a threshold value and determining that the value of the set of bits of the packet number initialization value is equal to or exceeds the threshold value. For example, the packet number initialization value may include the packet number initialization value 192 of FIG. 1, and the threshold may include the threshold 150 of FIG. 1.

The method 1100 may prevent a situation where a packet number is repeated while a particular group key is valid. For example, a device may be configured to determine whether an expiration condition of a particular group key is satisfied. If the expiration condition is satisfied, the device may prevent re-use of nonces (e.g., re-use of packet numbers) with the particular group key by initiating a group key expiration action (e.g., generation of a new group key or performance of a tear down of the data link group).

Referring to FIG. 12, a particular illustrative wireless communication device is depicted and generally designated 1200. The device 1200 includes a processor 1210, such as a digital signal processor, coupled to a memory 1232. In an illustrative implementation, the device 1200, or components thereof, may correspond to the devices 104-112 of FIG. 1, the device 200 of FIG. 2, the devices 104 and 106 of FIGS. 3 and 4, or components thereof.

The processor 1210 may be configured to execute software (e.g., a program of one or more instructions 1268) stored in the memory 1232 (e.g., a non-transitory computer readable medium). Additionally or alternatively, the processor 1210 may be configured to implement one or more instructions stored in a memory of a wireless interface 1240 (e.g., an Institute of Electrical and Electronics Engineers (IEEE) 802.11 compliant interface, a Wi-Fi Alliance compliant interface, or both). For example, the wireless interface 1240 may be configured to operate in accordance with one or more wireless communication standards, including one or more IEEE 802.11 standards, one or more Wi-Fi Alliance standards, one or more NAN standards, or a combination thereof. In a particular implementation, the processor 1210 may be configured to operate in accordance with one or more of the methods 800-1100 of FIGS. 8-11.

The processor 1210 may include the packet number generator 120, the packet generator 124, the encryption engine 127, the key expiration monitor 128, the key generator 134, and the data link group manage 136. In a particular implementation, the packet number generator 120 may determine a packet number based on a TSF value (in accordance with a packet number initialization scheme of a data link group), as described with reference to FIGS. 1 and 2. In another particular implementation, the packet number generator 120 may determine a packet number based on a packet number initialization value stored at the non-volatile memory 190 (in accordance with a packet number initialization scheme of a data link group), as further described with reference to FIGS. 1 and 2. The encryption engine 127 may encrypt data based on a packet number and a group key, as described with reference to FIGS. 1 and 2. The packet generator 124 may generate data packets that include encrypted data generated by the encryption engine 127, as described with reference to FIGS. 1 and 2. The key expiration monitor 128 may determine whether a key expiration condition associated with a group key is satisfied based on a TSF value, as described with reference to FIG. 1. The data link group manager 136 may initiate a group key expiration action of a data link group in response to an expiration condition being detected, as described with reference to FIG. 1. For example, the data link group manager may initiate a tear down of the data link group. As another example, the data link group manager 136 may cause the key generator 134 to generate a new group key.

The wireless interface 1240 may be coupled to the processor 1210 and to an antenna 1242. For example, the wireless interface 1240 may be coupled to the antenna 1242 via a transceiver 1246, such that wireless data received via the antenna 1242 and may be provided to the processor 1210.

A coder/decoder (CODEC) 1234 can also be coupled to the processor 1210. A speaker 1236 and a microphone 1238 can be coupled to the CODEC 1234. A display controller 1226 can be coupled to the processor 1210 and to a display device 1228. The non-volatile memory 190 may be coupled to the processor 1210 and configured to store the data link group association data 191 (including the packet number initialization value 192), as described with reference to FIG. 1. In a particular implementation, the processor 1210, the display controller 1226, the memory 1232, the CODEC 1234, the non-volatile memory 190, and the wireless interface 1240 are included in a system-in-package or system-on-chip device 1222. In a particular implementation, an input device 1230 and a power supply 1244 are coupled to the system-on-chip device 1222. Moreover, in a particular implementation, as illustrated in FIG. 12, the display device 1228, the input device 1230, the speaker 1236, the microphone 1238, the antenna 1242, and the power supply 1244 are external to the system-on-chip device 1222. However, each of the display device 1228, the input device 1230, the speaker 1236, the microphone 1238, the antenna 1242, and the power supply 1244 can be coupled to one or more components of the system-on-chip device 1222, such as one or more interfaces or controllers.

In a particular implementation, the device 1200 includes the memory 1232 that is configured to store the instructions 1268 and the processor 1210 that is coupled to the memory 1232. The processor 1210 and the memory 1232 are configured to perform operations (e.g., the instructions 1268, when executed by the processor 1210, cause the processor 1210 to perform the operations). The operations include joining a data link group of a neighbor aware network (NAN), setting a packet number to a particular value in accordance with a packet number initialization scheme of the data link group, and generating a packet based on the packet number.

In another particular implementation, the device 1200 includes the memory 1232 that is configured to store the instructions 1268 and the processor 1210 that is coupled to the memory 1232. The processor 1210 and the memory 1232 are configured to perform operations (e.g., the instructions 1268, when executed by the processor 1210, cause the processor 1210 to perform the operations). The operations include determining whether an expiration condition associated with a first group key of a data link group of a neighbor aware network (NAN) is satisfied based on a subset of bits of a timing synchronization function (TSF) value of the data link group or based on a packet number initialization value stored at a non-volatile memory. The operations further include initiating generation of a second group key of the data link group in response to the expiration condition being satisfied.

In another particular implementation, the device 1200 includes the memory 1232 that is configured to store the instructions 1268 and the processor 1210 that is coupled to the memory 1232. The processor 1210 and the memory 1232 are configured to perform operations (e.g., the instructions 1268, when executed by the processor 1210, cause the processor 1210 to perform the operations). The operations include determining whether an expiration condition associated with a first group key of a data link group of a neighbor aware network (NAN) is satisfied based on a subset of bits of a timing synchronization function (TSF) value of the data link group or based on a packet number initialization value stored at a non-volatile memory. The operations further include initiating a tear down operation for the data link group in response to the expiration condition being satisfied.

In another particular implementation, the device 1200 includes the memory 1232 that is configured to store the instructions 1268 and the processor 1210 that is coupled to the memory 1232. The processor 1210 and the memory 1232 are configured to perform operations (e.g., the instructions 1268, when executed by the processor 1210, cause the processor 1210 to perform the operations). The operations include determining whether an expiration condition associated with a first group key of a data link group of a neighbor aware network (NAN) is satisfied based on a subset of bits of a timing synchronization function (TSF) value of the data link group or based on a packet number initialization value stored at a non-volatile memory. The operations further include initiating a group key expiration action in response to the expiration condition being satisfied.

In conjunction with the described implementations, a first apparatus includes means for joining a data link group of a neighbor aware network (NAN). For example, the means for receiving may include the first device 104, the wireless interface 126 of FIG. 1, the device 200 of FIG. 2, the first device 104 of FIGS. 3 and 4, the processor 1210 programmed to execute the instructions 1268, the wireless interface 1240 of FIG. 12, one or more other devices, circuits, modules, or instructions to receive a frame from the device, or any combination thereof.

The first apparatus includes means for setting a packet number to a particular value in accordance with a packet number initialization scheme of the data link group. For example, the means for setting may include the packet number generator 120 of FIGS. 1 and 2, the processor 1210 programmed to execute the instructions 1268, the packet number generator 120 of FIG. 12, one or more other devices, circuits, modules, or instructions to set the packet number to a particular value in accordance with a packet number initialization scheme, or any combination thereof.

The first apparatus also includes means for generating a packet based on the packet number. For example, the means for generating may include the packet generator 124 of FIGS. 1 and 2, the processor 1210 programmed to execute the instructions 1268, the packet generator 124 of FIG. 12, one or more other devices, circuits, modules, or instructions to generate the packet based on the packet number, or any combination thereof.

In conjunction with the described implementations, a second apparatus includes means for determining, at a first device of a data link group of a NAN, whether an expiration condition associated with a first group key of the data link group is satisfied based on a subset of bits of a TSF value of the data link group or based on a packet number initialization value stored at a non-volatile memory of the first device. For example, the means for determining may include the first device 104, the second device 106, the key expiration monitor 128, the key expiration monitor 148 of FIG. 1, the first device 104 or the second device 106 of FIGS. 3 and 4, the processor 1210 programmed to execute the instructions 1268, the key expiration monitor 128 of FIG. 12, one or more other devices, circuits, modules, or instructions to determine whether the expiration condition is satisfied based on the subset of bits of the TSF value or based on the packet number initialization value, or any combination thereof.

The second apparatus also includes means for initiating generation of a second group key of the data link group in response to the expiration condition being satisfied. For example, the means for initiating may include the first device 104, the second device 106, the key generator 134, the key generator 154 of FIG. 1, the first device 104 or the second device 106 of FIGS. 3 and 4, the processor 1210 programmed to execute the instructions 1268, the key generator 134 of FIG. 12, one or more other devices, circuits, modules, or instructions to initiate generation of a second group key in response to the expiration condition being satisfied, or any combination thereof.

In conjunction with the described implementations, a third apparatus includes means for determining whether an expiration condition associated with a first group key of a data link group of a NAN is satisfied based on a subset of bits of a TSF value of the data link group or based on a packet number initialization value stored at a non-volatile memory. For example, the means for determining may include the first device 104, the second device 106, the key expiration monitor 128, the key expiration monitor 148 of FIG. 1, the first device 104 or the second device 106 of FIGS. 3 and 4, the processor 1210 programmed to execute the instructions 1268, the key expiration monitor 128 of FIG. 12, one or more other devices, circuits, modules, or instructions to determine whether the expiration condition is satisfied based on the subset of bits of the TSF value, or any combination thereof.

The third apparatus also includes means for initiating a tear down operation for the data link group in response to the expiration condition being satisfied. For example, the means for initiating may include the second device 106, the data link group manager 156 of FIG. 1, the second device 106 of FIGS. 3 and 4, the processor 1210 programmed to execute the instructions 1268, the data link group manager 136 of FIG. 12, one or more other devices, circuits, modules, or instructions to initiate the tear down operation in response to the expiration condition being satisfied, or any combination thereof.

In conjunction with the described implementations, a fourth apparatus includes means for receiving a frame from a device of a data link group of a NAN, the frame indicating a TSF value. For example, the means for receiving may include the first device 104, the wireless interface 126 of FIG. 1, the device 200 of FIG. 2, the first device 104 of FIGS. 3 and 4, the processor 1210 programmed to execute the instructions 1268, the wireless interface 1240 of FIG. 12, one or more other devices, circuits, modules, or instructions to receive a frame from the device, or any combination thereof.

The fourth apparatus includes means for determining a packet number based on the TSF value. For example, the means for determining may include the packet number generator 120 of FIGS. 1 and 2, the processor 1210 programmed to execute the instructions 1268, the packet number generator 120 of FIG. 12, one or more other devices, circuits, modules, or instructions to determine the packet number based on the TSF value, or any combination thereof.

The fourth apparatus also includes means for generating a packet based on the packet number. For example, the means for generating may include the packet generator 124 of FIGS. 1 and 2, the processor 1210 programmed to execute the instructions 1268, the packet generator 124 of FIG. 12, one or more other devices, circuits, modules, or instructions to generate the packet based on the packet number, or any combination thereof.

In conjunction with the described implementations, a fifth apparatus includes means for determining whether an expiration condition associated with a first group key of a data link group of a NAN is satisfied based on a subset of bits of a TSF value of the data link group. For example, the means for determining may include the second device 106, the key expiration monitor 148 of FIG. 1, the second device 106 of FIGS. 3 and 4, the processor 1210 programmed to execute the instructions 1268, the key expiration monitor 128 of FIG. 12, one or more other devices, circuits, modules, or instructions to determine whether the expiration condition is satisfied based on the subset of bits of the TSF value, or any combination thereof.

The fifth apparatus also includes means for initiating generation of a second group key of the data link group in response to the expiration condition being satisfied. For example, the means for initiating may include the second device 106, the key generator 154 of FIG. 1, the second device 106 of FIGS. 3 and 4, the processor 1210 programmed to execute the instructions 1268, the key generator 134 of FIG. 12, one or more other devices, circuits, modules, or instructions to initiate generation of a second group key in response to the expiration condition being satisfied, or any combination thereof.

In conjunction with the described implementations, a sixth apparatus includes means for determining whether an expiration condition associated with a first group key of a data link group of a NAN is satisfied based on a subset of bits of a TSF value of the data link group. For example, the means for determining may include the second device 106, the key expiration monitor 148 of FIG. 1, the second device 106 of FIGS. 3 and 4, the processor 1210 programmed to execute the instructions 1268, the key expiration monitor 128 of FIG. 12, one or more other devices, circuits, modules, or instructions to determine whether the expiration condition is satisfied based on the subset of bits of the TSF value, or any combination thereof.

The sixth apparatus also includes means for initiating a tear down operation for the data link group in response to the expiration condition being satisfied. For example, the means for initiating may include the second device 106, the data link group manager 156 of FIG. 1, the second device 106 of FIGS. 3 and 4, the processor 1210 programmed to execute the instructions 1268, the data link group manager 136 of FIG. 12, one or more other devices, circuits, modules, or instructions to initiate the tear down operation in response to the expiration condition being satisfied, or any combination thereof.

In conjunction with the described implementations, a seventh apparatus includes means for determining whether an expiration condition associated with a first group key of a data link group of a NAN is satisfied based on a subset of bits of a TSF value of the data link group. For example, the means for determining may include the second device 106, the key expiration monitor 148 of FIG. 1, the second device 106 of FIGS. 3 and 4, the processor 1210 programmed to execute the instructions 1268, the key expiration monitor 128 of FIG. 12, one or more other devices, circuits, modules, or instructions to determine whether the expiration condition is satisfied based on the subset of bits of the TSF value, or any combination thereof.

The seventh apparatus also includes means for initiating a group key expiration action in response to the expiration condition being satisfied. For example, the means for initiating may include the second device 106, the data link group manager 156 of FIG. 1, the second device 106 of FIGS. 3 and 4, the processor 1210 programmed to execute the instructions 1268, the data link group manager 136 of FIG. 12, one or more other devices, circuits, modules, or instructions to initiate the group key expiration operation in response to the expiration condition being satisfied, or any combination thereof.

One or more of the disclosed aspects may be implemented in a system or an apparatus, such as the device 1200, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the device 1200 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle, any other device that includes a processor or that stores or retrieves data or computer instructions, or a combination thereof. As another illustrative, non-limiting example, the system or the apparatus may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

Although one or more of FIGS. 1-12 may illustrate systems, apparatuses, and/or methods according to the teachings of the disclosure, the disclosure is not limited to these illustrated systems, apparatuses, and/or methods. One or more functions or components of any of FIGS. 1-12 as illustrated or described herein may be combined with one or more other portions of another of FIGS. 1-12. Accordingly, no single implementation described herein should be construed as limiting and implementations of the disclosure may be suitably combined without departing form the teachings of the disclosure. As an example, the method 500 of FIG. 5, the method 600 of FIG. 6, the method 700 of FIG. 7, the method 800 of FIG. 8, the method 900 of FIG. 9, the method 1000 of FIG. 10, the method 1100 of FIG. 11, or a combination thereof, may be performed by processors of the devices 104-112 of FIG. 1, the device 200 of FIG. 2, or the devices 104 and 106 of FIGS. 3 and 4. To illustrate, a portion of the method 500 of FIG. 5, the method 600 of FIG. 6, the method 700 of FIG. 7, the method 800 of FIG. 8, the method 900 of FIG. 9, the method 1000 of FIG. 10, the method 1100 of FIG. 11, or a combination thereof, may be combined with other operations described herein. Additionally, one or more operations described with reference to the method 500 of FIG. 5, the method 600 of FIG. 6, the method 700 of FIG. 7, the method 800 of FIG. 8, the method 900 of FIG. 9, the method 1000 of FIG. 10, the method 1100 of FIG. 11, or a combination thereof, may be optional, may be performed at least partially concurrently, and/or may be performed in a different order than shown or described.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the disclosure herein may be implemented directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A wireless communication device, comprising:
a memory; and
a processor coupled to the memory and configured to:
set a packet number to a particular value in accordance with a packet number initialization scheme associated with a data link group of a neighbor aware network (NAN); and
generate a packet based on the packet number.

2. The wireless communication device of claim 1, further comprising a wireless interface configured to transmit the packet to at least one device of the data link group, wherein the data link group comprises multiple devices configured to be in an active state during one or more designated time periods.

3. The wireless communication device of claim 1, further comprising a non-volatile memory configured to store data link group association data associated with a group key of the data link group, wherein the data link group association data indicates a packet number initialization value used to initialize the packet number.

4. The wireless communication device of claim 1, wherein the processor is further configured to:
generate a nonce based on the packet number and a media access control (MAC) address; and
encrypt data based on the nonce and a temporal key to generate encrypted data, wherein the packet includes the encrypted data.

5. The wireless communication device of claim 4, wherein the processor is further configured to perform counter mode cipher block chaining message authentication code protocol (CCMP) encryption to generate the encrypted data.

6. The wireless communication device of claim 1, further comprising a wireless interface configured to receive a frame from a second device of the data link group, the frame indicating a timing synchronization function (TSF) value, wherein the packet number is set based on the TSF value.

7. A method of wireless communication, the method comprising:
performing one or more operations at a first device to join a data link group of a neighbor aware network (NAN);
setting a packet number to a particular value in accordance with a packet number initialization scheme of the data link group; and
generating a packet by the first device based on the packet number.

8. The method of claim 7, further comprising transmitting the packet to a second device of the data link group, wherein the packet includes data that is encrypted using a nonce that is generated based on the packet number.

9. The method of claim 7, further comprising receiving a frame at the first device from a second device of the data link group, the frame indicating a timing synchronization function (TSF) value, wherein the packet number is set based on the TSF value, wherein the packet number initialization scheme includes setting one or more packet numbers based on one or more TSF values, and wherein the packet number initialization scheme corresponds to group-addressed traffic.

10. The method of claim 9, wherein the particular value comprises a set of bits of the TSF value or a result of a modulo operation performed on the TSF value.

11. The method of claim 7, wherein the packet number initialization scheme includes storing one or more packet number initialization values associated with the data link group at a non-volatile memory of the first device, and wherein the packet number initialization scheme corresponds to group-addressed traffic.

12. The method of claim 7, further comprising accessing, at the first device, data link group association data stored at a non-volatile memory of the first device after performing the one or more operations, wherein the packet number is set to a packet number initialization value stored at the non-volatile memory.

13. The method of claim 12, further comprising:
incrementing a packet number counter after generating the packet;
determining whether a difference between a value of the packet number counter and the packet number initialization value is less than or equal to an update threshold; and
in response to determining that the difference is less than or equal to the update threshold, updating the packet number initialization value at the non-volatile memory.

14. A wireless communication device, comprising:
a memory; and
a processor coupled to the memory and configured to:
determine whether an expiration condition associated with a first group key of a data link group of a neighbor aware network (NAN) is satisfied based on a subset of bits of a timing synchronization function (TSF) value of the data link group or based on a packet number initialization value stored at a non-volatile memory; and
initiate a group key expiration action in response to the expiration condition being satisfied.

15. The wireless communication device of claim 14, further comprising a comparator configured to compare a value of the subset of bits of the TSF value to a threshold value, wherein the expiration condition is detected in response to the value of the subset of bits of the TSF value exceeding the threshold value.

16. The wireless communication device of claim 14, further comprising a comparator configured to compare a value of a set of bits of the packet number initialization value to a threshold value, wherein the expiration condition is detected in response to the value of the set of bits of the packet number initialization value being equal to or exceeding the threshold value.

17. The wireless communication device of claim 14, wherein the group key expiration action comprises initiating generation of a second group key or performing a tear down operation for the data link group.

18. The wireless communication device of claim 17, wherein the processor is further configured to generate the second group key.

19. The wireless communication device of claim 18, further comprising a wireless interface configured to transmit the second group key to at least one device of the data link group.

20. The wireless communication device of claim 17, further comprising a wireless interface configured to transmit a termination message to at least one other device of the data link group, wherein performing the tear down operation comprises transmitting the termination message.
